(19) United States
(12) Patent Application Publication
(10) Pub. No.: US 2024/0063368 A1
(43) Pub. Date: Feb. 22, 2024

(54) METHOD FOR PRODUCING A POROUS ANODE FOR A LITHIUM-ION SECONDARY BATTERY, RESULTING ANODE, AND BATTERY COMPRISING SAID ANODE

(71) Applicant: I-TEN, Dardilly (FR)

(72) Inventor: Fabien GABEN, Dardilly (FR)

(73) Assignee: I-TEN, Dardilly (FR)

(21) Appl. No.: 18/269,810

(22) PCT Filed: Dec. 23, 2021
(86) PCT No.: PCT/IB2021/062263

§ 371 Date: Jun. 27, 2023

(30) Foreign Application Priority Data
Dec. 29, 2020 (FR) FR2014220

(51) Int. Cl. H01M 4/1391; H01M 4/04; H01M 10/0525

(52) U.S. Cl. CPC H01M 4/1391; H01M 4/043; H01M 4/0457; H01M 10/0525; H01M 2004/027

(57) ABSTRACT

A method for manufacturing an anode having a porosity of between 25% and 50% by volume, wherein: (a) a substrate and a colloidal suspension or a paste composed of monodispersed primary nanoparticles, in the form of agglomerates or dispersed, is provided of at least one active material of anode A selected from niobium oxides and mixed oxides of niobium with titanium, germanium, cerium, lanthanum, copper or tungsten, with an average primary diameter D50 of between 2 nm and 100 nm; (b) on at least one face of said substrate a layer of the colloidal suspension or paste provided in step (a) is deposited by a method selected from the group including: electrophoresis, a printing process and preferably inkjet printing or flexographic printing, a coating method and preferably doctor blade coating, roll coating, curtain coating, dip coating or through a slot die; (c) the layer obtained in step (b) is dried and consolidated by pressing and/or heating to obtain a porous layer.

### CROSS-REFERENCE TO RELATED APPLICATIONS

This application is a national phase entry of PCT Patent Application Serial No. PCT/IB2021/062263, filed on Dec. 23, 2021, which claims priority to French Patent Application Serial No. FR2014220, filed on Dec. 29, 2020, both of which are incorporated by reference herein.

### TECHNICAL FIELD

The invention relates to the field of electrochemistry and more particularly to electrochemical systems. It relates more particularly to electrodes used in batteries having a capacity greater than 1 mA h. The invention relates to a new method for manufacturing porous anodes which can be used in electrochemical systems such as high-power batteries (in particular lithium-ion batteries). This method uses nanoparticles of an anode material.

The invention also relates to the anodes obtained by this method, which are mesoporous. The invention also relates to batteries comprising such a porous anode. In this respect, the invention also relates to a method for preparing a lithium-ion battery formed from such a mesoporous anode, which is in contact with a porous separator, the latter also being in contact with a porous cathode. These porous electrode/separator assemblies may be impregnated with a liquid electrolyte.

More precisely the invention relates to anodes combining the following features: a high volumetric capacity (expressed in mAh/cm³), a sufficiently high insertion potential to allow rapid recharging without any risk of lithium plating, and the absence of significant variations in volume during the charging and discharging steps of the battery, such that said battery can be used in the form of a rigid, monobloc entirely solid and mesoporous structure.

### BACKGROUND

Batteries that are ideal for powering autonomous electrical devices (such as: phones and laptops, hand-held tools, autonomous sensors) or for driving electric vehicles should have a long life, should be capable of storing large amounts of both energy and power, should be able to function over a very broad temperature range and should not be at risk of overheating or explosion. Currently, these electrical devices are powered essentially by lithium-ion batteries, which have the best energy density of the different storage technologies proposed. There are different architectures and chemical compositions of electrodes which make it possible to produce lithium-ion batteries. Methods for manufacturing lithium-ion batteries are presented in numerous and patents, and the works “Advances in Lithium-Ion Batteries” (Ed. W. van Schalkwijk and B. Scrosati), published in 2002 (Kluever Academic/Plenum Publishers), and “Lithium Batteries. Science and Technology” by C. Julien, A. Mauger, A. Vijh and K. Zaghib (Springer, Heidelberg 2016) provide a good overview.

The electrodes of lithium-ion batteries can be manufactured by using known coating techniques (in particular techniques such as roll coating, curtain coating, slot die coating, doctor blade coating and tape casting). With these methods, the active materials used to make the electrodes are used in the form of powder suspensions with an average particle size of between 5 μm and 15 μm in diameter. These particles are integrated into an ink which consists of these particles, organic binders and a filler of powder of an electronically conductive material (conductive filler), typically carbon black. This ink is deposited on the surface of a metal substrate, then dried to remove the organic solvents it contains and to leave only a porous deposit on the surface of the metal strip consisting of the particles of active materials bonded mechanically together by organic binders and connected electrically by carbon black.

These techniques make it possible to obtain layers with thickness of between about 20 μm and about 400 μm. Depending on the thickness of the layers, their porosity and the size of the active particles, the power and the energy of the battery can be modulated.

According to the prior art, the inks (or pastes) deposited to form the electrodes contain particles of active materials, but also (organic) binders, carbon powder to ensure the electrical contact between the particles, and solvents which are evaporated in the drying step of the electrodes. To improve the quality of the electrical contact between the particles and to compact the deposited layers, a calendering step is performed on the electrodes. After this compression step, the active particles of the electrodes occupy about 60-70% of the volume of the deposit, which means that generally 30 to 40% of the porosity remains between the particles.

In order to optimise the volumetric energy density of lithium-ion batteries produced with these convention manufacturing methods, it can be very useful to reduce the porosity of the electrodes. This reduction in porosity, in other words the increase in the amount of active material per unit volume of the electrode, can be achieved in several ways.

At the extreme, the electrode films with the highest energy densities per volume are made using vacuum deposition techniques, for example PVD. These films are completely dense, and are not porous. However, as these completely solid films do not contain liquid electrolytes to facilitate ionic transport or an electronic conductive charge for facilitating the transport of electrical charges, their thickness remains limited to several microns so as to prevent them becoming too resistive.

With standard inking techniques it is also possible to increase the volumetric energy density by optimising the size distribution of the deposited particles. Indeed, as shown for example in the article by J. Ma and L. C. Lim “Effect of particle size distribution on sintering of agglomerate-free submicron alumina powder compacts” published in 2002 in the review J. European Ceramic Society 22 (2002), pp. 2197-2208, by optimising the particle size distribution, it is possible to achieve a density of about 70%. An electrode having 30% porosity, containing conductive charges and impregnated with a conductive electrolyte of lithium ions will have a volume energy density about 35% higher than the same electrode with 50% porosity consisting of monodisperse particles in size.

Furthermore, due to the impregnation with highly ionic conductive phases and the addition of electronic conductors, the thickness of these electrodes may be largely increased compared to that which can be achieved with vacuum deposition techniques. These increases in thickness also contribute to an increase in the energy density of the battery cells. Although this increases the energy density of the electrodes, this size distribution of the active material particles is not without problems. Particles of different sizes in an electrode will have different capacities and under the effect of identical charge and/or discharge currents will be locally more or less charged and/or discharged according to their size. When the battery is no longer under current load, the local charge states between the particles will be balanced again, but during these transitory phases, the local imbalances may lead to particles being locally loaded outside their stable voltage ranges. These imbalances in local charge states will be more pronounced the higher the current densities. These imbalances therefore lead to losses in cycling performance, safety risks and a limitation of the power of the battery cell.

These effects of active material particle size distribution on electrode current/voltage relationships have been studied and simulated by S. T. Taleghani et al in publication “A study on the effect of porosity and particles size distribution on Li-ion battery performance”, published in J. Electrochemical Society, 164 (11) 2017, p. E3179-E3189. With the electrode inking techniques of the prior art, the particles of active material have a size of generally between 5 μm and 15 μm. The contact between two adjacent particles is essentially point-like, the particles being bonded by an organic binder which is in most cases PVDF.

The liquid electrolytes used for impregnating the electrodes consist of aprotic solvents in which lithium salts have been dissolved. These organic electrolytes are highly flammables and may cause a violent combustion of the battery cells, especially when the active cathode materials are loaded in voltage ranges outside their stability voltage range or when hot spots occur locally in the cell.

To address these safety problems inherent in the structure of conventional lithium-ion battery cells, it is necessary to:
replace organic solvent-based electrolytes with highly temperature-stable ionic liquids. However, the ionic liquids do not wet on the surfaces of organic materials and the presence of PVDF and other organic binders in conventional battery electrodes prevent wetting of the electrodes by this type of electrolyte and the performance of the electrodes is affected. Ceramic separators have been developed to solve this problem at the electrolyte junction between electrodes, but the presence of organic binders in electrodes continues to pose problems for the use of ionic liquid electrolytes;
homogenise the particle sizes, so as to avoid local imbalances in the charge states which may lead, during intense discharges, to active materials being locally stressed outside their conventional voltage operating ranges. This optimisation would then negatively affect the energy density of the cell;
homogenise the distribution of conductive charges (carbon black) in the electrode, to avoid having more electrically resistive areas locally that would lead to the formation of hot spot during the power operation of the battery.

With regard more particularly to the methods for manufacturing battery electrodes according to the prior art, their manufacturing cost depends in part on the nature of the solvents used. In addition to the intrinsic cost of active materials, the cost of manufacturing electrodes is essentially due to the complexity of the inks used (binders, solvents, carbon black . . . ).

The main solvent used to make electrodes of lithium-ion batteries is NMP. NMP is an excellent solvent for dissolving PVDF which acts as a binder in the formulation of inks. The drying of the NMP contained in the electrodes is a real economic issue. The high boiling point of NMP coupled with a very low vapour pressure makes it difficult to dry. The vapours of solvents have to be collected and reprocessed. Furthermore, to guarantee better adherence of the electrodes to the substrates the drying temperature of the NMP should not be too high, which tends to increase the drying time and cost further; this is described in publication “Technical and economic analysis of solvent-based lithium-ion electrode drying with water and NMP” by D. L. Wood et al, published in Drying Technology, vol. 36, no 2 (2018).

Other less expensive solvents can be used to make inks, in particular water and ethanol. However, their surface tension is greater than that of NMP, and they wet the surface of the metal current collectors less effectively. In addition, the particles have a tendency to agglomerate in water, especially the carbon black nanoparticles. These agglomerations lead to a heterogeneous distribution of the components entering the composition of the electrode (binders, carbon black . . . ). In addition, either in water or ethanol, traces of water can remain adsorbed on the surface of the active material particles, even after drying.

Lastly, in addition to the problems of formulating inks to achieve a high-performance, low-cost electrode, it is also important to bear in mind that depending on the particle size of the active materials, and indirectly the porosity of the electrode deposits and their thicknesses, the ratio between the energy density and the power density of the electrodes can be adjusted. The article by J. Newman “Optimization of Porosity and Thickness of a Battery Electrode by Means of a Reaction-zone Model”, published in the review J. Electrochem. Soc., Vol. 142, n° 1 (1995), shows the respective effects of the thicknesses of electrodes and their porosity on their discharge power and energy density.

In addition to the architecture and the manufacturing methods of the battery cells, the choice of electrode materials is also fundamental. The energy stored in the batteries is the product of the electrode capacity in Ah or mAh multiplied by the operating voltage of the cell. This operating voltage is the difference between the lithium insertion potentials in the anodes and cathodes.

The lower the lithium insertion potential of the anodes, the higher the energy of the battery at iso-capacity. However, the anodes with low insertion potential such as graphite, run the risk of lithium “plating” at a high recharge current. Indeed, in order to rapidly recharge the battery, it is necessary to rapidly insert a large amount of lithium into the anodes. A high concentration of lithium on the surface of the anode, associated with a very low potential, favours the precipitation of metal lithium dendrites which will induce short circuits in the cell. In addition, if one wishes to obtain batteries with a very rapid recharging capacity, without any safety risks due to lithium plating and for which the energy density of the cell would remain high, it is necessary at the same time:
to use anodes inserting the lithium at a relatively high voltage (higher than 0.5 V/Li) to avoid the formation of lithium dendrites during fast recharging phases. These anodes also have to have very high mass capacities in order to compensate for energy losses by reducing the operating voltage by increasing their capacity;
to have electrodes with a very large specific surface area, and particle sizes (thickness of the insertion zones) that are as homogenous as possible to avoid dynamic imbalances;
to have electrodes with excellent ionic and electronic conductivity.
to have electrolytes with very good ionic conductivity with high transport numbers and low polarisation resistances.

The present invention aims to propose a lithium-ion battery which has at least some of these technical features and which preferably has all of these features. According to the invention, this problem is solved by a judicious choice of material of the anode and its structure, and by a manufacturing method which makes it possible to obtain an anode with such a structure.

### SUMMARY

According to the invention the problem is solved by a method for manufacturing a porous anode for a battery designed to have a capacity greater than 1 mA h comprising an anode, a separator and a cathode, said anode having a porosity of between 25 and 50% by volume, and preferably about 35% by volume, and pores with an average diameter of less than 50 nm, according to a particular method which forms the first object of the invention. The anode according to the invention is advantageously used in batteries designed to have a capacity greater than 1 mA h.

The method for manufacturing the porous anode for a battery according to the invention comprises the following steps:
(a) providing a substrate and a colloidal suspension or a paste composed of monodisperse primary nanoparticles, in the form of agglomerates or dispersed, of at least one active material of anode A, with an average primary diameter D₅₀ of between 2 nm and 100 nm, and preferably of between 2 nm and 60 nm, provided that said colloidal suspension or said paste also comprises a liquid component, provided that active material of anode A is selected from oxides of niobium and the mixed oxides of niobium with titanium, germanium, cerium, lanthanum, copper or tungsten, and preferably in groups formed by:
   Nb₂O_{5-δ}, Nb₁₈W₁₆O_{93-δ}, Nb₁₆W₅O_{55-δ} with 0≤x<1 and 0≤δ≤2
   TiNb₂O_{7-δ}, Ti₁₋ₓM¹ₓNb_{2-y}M²_{y}O_{7-δ}, Li_{w}Ti₁₋ₓM¹ₓNb_{2-y}M²_{y}O_{7-δ} wherein M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn, M¹ and M² can be identical or different from one another, and wherein 0≤w≤5 and 0≤x≤1 and 0≤y≤2 and 0≤δ≤0.3;
   Ti₁₋ₓNb_{2-y}M²_{y}O_{7-z}M³_{z}, Li_{w}Ti₁₋ₓM¹ₓNb_{2-y}M²_{y}O_{7-z}M³_{z} wherein
      M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
      M¹ and M² can be identical or different from one another,
      M³ is at least one halogen,
      and wherein 0≤w≤5 and 0≤x≤1 and 0≤y≤2 and z≤0.3;
   TiNb₂O_{7-z}M³_{z}, Li_{w}TiNb₂O_{7-z}M³_{z} wherein M³ is at least one halogen, preferably selected from F, Cl, Br, I or a mixture thereof, and 0≤w≤5 and 0<z≤0.3;
   Ti₁₋ₓGeₓNb_{2-y}M¹_{y}O_{7-z}M²_{z}, Li_{w}Ti₁₋ₓGeₓNb_{2-y}M¹_{y}O_{7-z}M²_{z}, Ti₁₋ₓLaₓNb_{2-y}M¹_{y}O_{7-z}M²_{z}, Li_{w}Ti₁₋ₓLaₓNb_{2-y}M¹_{y}O_{7-z}M²_{z}, Ti₁₋ₓCuₓNb_{2-y}M¹_{y}O_{7-z}M²_{z}, Li_{w}Ti₁₋ₓCuₓNb_{2-y}M¹_{y}O_{7-z}M²_{z}, Ti₁₋ₓCeₓNb_{2-y}M¹_{y}O_{7-z} M²_{z}, Li_{w}Ti₁₋ₓCeₓNb_{2-y}M¹_{y}O_{7-z}M²_{z} wherein
      M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
      M¹ and M² can be identical or different from one another,
      and wherein 0≤w≤5 and 0≤x≤1 and 0≤y≤2 and z≤0.3;
   Ti₁₋ₓGeₓNb_{2-y}M¹_{y}O_{7-z}, Li_{w}Ti₁₋ₓGeₓNb_{2-y}M¹_{y}O_{7-z}, Ti₁₋ₓCeₓNb_{2-y}M¹_{y}O_{7-z}, Li_{w}Ti₁₋ₓCeₓNb_{2-y}M¹_{y}O_{7-z} wherein
      M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
      and wherein 0≤w≤5 and 0≤x≤1 and 0≤y≤2 and z<1, preferably wherein 0≤w≤5 and 0≤x≤1 and 0≤y≤2 and z<0.3;
(b) depositing on at least one side of said substrate a layer from said colloidal suspension or paste provided in step (a), by a method selected from the group formed by: electrophoresis, extrusion, a printing method and preferably ink-jet printing or flexographic printing, a coating method and preferably doctor blade coating, roll coating, curtain coating, dip coating or through a slot die;
(c) drying said layer obtained in step (b) and consolidating it, by pressing and/or heating, to obtain a porous layer.

Advantageously, said active material of anode A may also be selected from oxides of niobium and mixed oxides of niobium with titanium, germanium, cerium, lanthanum, copper, or tungsten, and preferably from groups formed by:
Nb₂O_{5-δ}, Nb₁₈W₁₆O_{93-δ}, Nb₁₆W₅O_{55-δ} with 0≤x<1 and 0<δ≤2
TiNb₂O_{7-δ} with 0<δ≤0.3, Ti₁₋ₓM¹ₓNb_{2-y}M²_{y}O_{7-δ}, Li_{w}Ti₁₋ₓM¹ₓNb_{2-y}M²_{y}O_{7-δ} wherein M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn, wherein M¹ and M² can be identical or different from one another, and wherein 0≤w≤5 and 0≤x≤1 and 0≤y≤2 and 0≤δ≤0.3;
Ti₁₋ₓM¹ₓNb_{2-y}M²_{y}O_{7-z}M³_{z}, Li_{w}Ti₁₋ₓM¹ₓNb_{2-y}M²_{y}O_{7-z}M³_{z} wherein
   M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
   M¹ and M² can be identical or different from one another,
   M³ is at least one halogen,
   and wherein 0≤w≤5 and 0≤x≤1 and 0≤y≤2 and z≤0.3;
TiNb₂O_{7-z}M³_{z}, Li_{w}TiNb₂O_{7-z}M³_{z} wherein M³ is at least one halogen, preferably selected from F, Cl, Br, I or a mixture thereof, and 0≤w≤5 and 0<z≤0.3;
Ti₁₋ₓGeₓNb_{2-y}M¹_{y}O_{7-z}M²_{z}, Li_{w}Ti₁₋ₓGeₓNb_{2-y}M¹_{y}O_{7-z}M²_{z}, Ti₁₋ₓLaₓNb_{2-y}M¹_{y}O_{7-z}M²_{z}, Li_{w}Ti₁₋ₓLaₓNb_{2-y}M¹_{y}O_{7-z}M²_{z}, Ti₁₋ₓCuₓNb_{2-y}M¹_{y}O_{7-z}M²_{z}, Li_{w}Ti₁₋ₓCuₓNb_{2-y}M¹_{y}O_{7-z}M²_{z}, Ti₁₋ₓCeₓNb_{2-y}M¹_{y}O_{7-z} M²_{z}, Li_{w}Ti₁₋ₓCeₓNb_{2-y}M¹_{y}O_{7-z}M²_{z} wherein
   M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
   M¹ and M² can be identical or different from one another,
   and wherein 0≤w≤5 and 0<x≤1 and 0≤y<2 and z≤0.3;
Ti₁₋ₓGeₓNb_{2-y}M¹_{y}O_{7-z}, Li_{w}Ti₁₋ₓGeₓNb_{2-y}M¹_{y}O_{7-z}, Ti₁₋ₓCeₓNb_{2-y}M¹_{y}O_{7-z}, Li_{w}Ti₁₋ₓCeₓNb_{2-y}M¹_{y}O_{7-z} wherein
   M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
   and wherein 0≤w≤5 and 0<x≤1 and 0≤y<2 and z<1, preferably wherein 0≤w≤5 and 0≤x≤1 and 0≤y≤2 and z<0.3.

In an optional manner, during step (c) said layer is heated to a high enough temperature to remove organic residues by evaporation and/or pyrolysis (referred to as a debinding step). In a more general manner, the treatments of step (c) are performed in several steps, or in a continuous temperature ramp. This treatment starts with drying, followed optionally by debinding if the deposit contains organic materials (this debinding is a heat treatment in air for pyrolysing or calcining the organic materials), and lastly a consolidation treatment which can be only a heat treatment and/or a thermomechanical treatment.

The active materials of anode A represented by formulae indicating the possible presence of lithium, namely Li_{w}Ti₁₋ₓM¹ₓNb_{2-y}M²_{y}O₇, Li_{w}Ti₁₋ₓM¹ₓNb_{2-y}M²_{y}O_{7-z}M³_{z}, Li_{w}Ti₁₋ₓGeₓNb_{2-y}M¹O_{7-z}M²_{z}, Li_{w}Ti₁₋ₓGeₓNb_{2-y}M¹_{y}O_{7-z}, Li_{w}Ti₁₋ₓLaₓNb_{2-y}M¹_{y}O_{7-z}M²_{z}, Li_{w}Ti₁₋ₓCuₓNb_{2-y}M¹_{y}O_{7-z}M²_{z}, Li_{w}Ti₁₋ₓCeₓNb_{2-y}M¹_{y}O_{7-z}M²_{z} and Li_{w}Ti₁₋ₓCeₓNb_{2-y}M¹_{y}O_{7-z}, are supplied and deposited with w=0 (i.e. without containing lithium): these materials have the ability to insert lithium during the first charge of the battery in which the anode forms a part. In step (b) the deposit can be made on both sides of the substrate.

In a first embodiment, said substrate can be a substrate capable of acting as an electric current collector. The thickness of the layer after step (c) is advantageously of between about 1 μm and about 300 μm, or of between 1 μm and 150 μm.

In a second embodiment, said substrate is an intermediate, temporary substrate, such as a polymer film. In this second embodiment the layer can be separated from its substrate after drying, preferably before heating it, but at the latest at the end of step (c). The thickness of the layer after step (c) is advantageously between about 5 μm and about 300 μm.

In the two embodiments, if the layers are thick and resistive it is advantageous to add step (d) in which:
(d) a coating of electronically conductive material is deposited, i.e. formed, on and within the pores of said porous layer, said electronically conductive material being preferably carbon or an electronically conductive oxide material.
Step (d) may be performed by ALD.
Step (d) may comprise the following successive steps, where a layer of a precursor of an electronically conductive material is deposited in step (d1) on and inside the pores of said porous layer, and in step (d2), the precursor of an electronically conductive material, deposited in step (d1) on said porous layer, is transformed into electronically conductive material, so that said porous layer has a layer of said electronically conductive material on and inside the pores.

The electronically conductive material may be carbon. In this case, step (d1) is advantageously performed by the immersion of the porous layer in a liquid phase comprising a carbon-rich compound, such as a carbohydrate, and said transformation into electronically conductive material performed in step (d2) is in this case pyrolysis, preferably performed in an insert atmosphere, more preferably in nitrogen. Step (d1) is advantageously performed by immersion of the porous layer in a liquid phase comprising a precursor of said electronically conductive material, and, in this case, said transformation of the precursor of an electronically conductive material into electronically conductive material in step (d2) is a heat treatment such as calcination, preferably performed in air or in an oxidising atmosphere.

Advantageously, said precursor of the electronically conductive material is selected from organic salts containing one or more metal elements capable, after heat treatment such as calcination preferably carried out in air or in an oxidising atmosphere, of forming an electronically conductive oxide. These metal elements, preferably, these metal cations, can advantageously be selected from tin, zinc, indium, gallium or a mixture of two or three or four of these elements. The organic salts are preferably selected from an alcoholate of at least one metal element capable, after heat treatment such as calcination preferably performed in air or in an oxidising atmosphere, of forming an electronically conductive oxide, an oxalate of at least one metal element which is capable, after calcination in air, of forming an electronic conductive oxide, and an acetate of at least one metal element which is capable, after heat treatment such as calcination preferably performed in air or in an oxidising atmosphere, of forming an electronically conductive oxide.

Advantageously, said electronically conductive material may be an electronically conductive oxide material, preferably selected from:
tin oxide (SnO₂), zinc oxide (ZnO), indium oxide (In₂O₃), gallium oxide (Ga₂O₃), a mixture of two of these oxides such as indium-tin oxide corresponding to a mixture of indium oxide (In₂O₃) and tin oxide (SnO₂), a mixture of three of these oxides or a mixture of four of these oxides,
doped oxides based on zinc oxide, the doping being preferably with gallium (Ga) and/or aluminium (AI) and/or boron (B) and/or beryllium (Be), and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped oxides based on indium oxide, the doping being preferably with tin (Sn), and/or gallium (Ga) and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped tin oxides, the doping being preferably with arsenic (As) and/or fluorine (F) and/or nitrogen (N) and/or niobium (Nb) and/or phosphorus (P) and/or antimony (Sb) and/or aluminium (AI) and/or titanium (Ti), and/or gallium (Ga) and/or chromium (Cr) and/or cerium (Ce) and/or indium (In) and/or cobalt (Co) and/or nickel (Ni) and/or copper (Cu) and/or manganese (Mn) and/or germanium (Ge).

In a general manner, said primary nanoparticles are advantageously in the form of aggregates or agglomerates, said aggregates or agglomerates having an average diameter D₅₀ of between 50 nm and 300 nm, and preferably of between 100 nm and 200 nm. Said porous layer from step (c) has a specific surface area of between 10 m²/g and 500 m²/g. The deposit of said coating of electronically conductive material is performed by the technique of atomic layer deposition (ALD) or by immersion in a liquid phase comprising a precursor of said electronically conductive material, followed by the transformation of said precursor into electronically conductive material.

In said second embodiment, the method for manufacturing the porous anode for a battery uses an intermediate substrate made of a polymer (such as PET) and results in a so-called “green tape”. This green tape is then separated from its substrate; it then forms plates or sheets (referred to in the following by the term “plate”, regardless of its thickness).

These plates may be cut before or after separation from their intermediate substrate. These plates are then calcined in order to remove the organic constituents. These plates are then sintered in order to consolidate the nanoparticles until a mesoporous ceramic structure is obtained with a porosity of between 25 and 50%. Said porous plate obtained in step (c) advantageously has a thickness of between 5 μm and 300 μm. It is advantageous to deposit a coating of an electronically conductive material, as described above.

In this second embodiment a metal sheet is also provided, covered on both sides with an intermediate thin layer of nanoparticles, preferably identical to those constituting the electrode plate. Said thin layer preferably has a thickness of less than 1 μm.

This sheet is then inserted between two porous electrode plates obtained previously (for example two porous anode plates). The assembly is then heat pressed so that said thin intermediate layer of nanoparticles is transformed by sintering and consolidates the electrode/substrate/electrode assembly to obtain a rigid and monobloc assembly. During this sintering the bond between the electrode layer and the intermediate layer is established by the diffusion of atoms; this phenomenon is known as diffusion bonding. This assembly is made with two electrode plates of the same polarity (typically between two anodes), and the metal sheet between these two electrode plates of the same polarity establishes a parallel connection between them.

One of the advantages of the second embodiment is that it allows the use of inexpensive substrates such as aluminium or copper foils. Indeed, these foils would not withstand the heat treatments used to consolidate the deposited layers, the fact that they are glued to the electrode plates after their heat treatment also prevents their oxidation.

This assembly by diffusion bonding can be carried out separately as described above, and the resulting electrode/substrate/electrode subassemblies can be used to manufacture a battery. This assembly by diffusion bonding can also be performed by stacking and heat pressing the entire battery structure; in this case a multilayer stack is assembled comprising a first porous anode layer according to the invention, its metal substrate, a second porous anode layer according to the invention, a solid electrolyte layer, a first cathode layer, its metal substrate, a second cathode layer, a new solid electrolyte layer, and so on.

More precisely, one can either glue plates of mesoporous ceramic electrodes (and in particular anodes according to the invention) to both faces of a metal substrate (the same configuration as the one with deposits on both faces of a metal substrate). The electrolyte film (separator) is then deposited on this electrode/substrate/electrode (and in particular anode/substrate/anode). The necessary cuts are then made to produce a battery with several elementary cells, them the sub-assemblies are stacked (typically in a head-to-tail manner) and thermocompression is performed to bond the electrodes to one another at the level of the solid electrolyte.

Alternatively, the stack can be formed comprising the first electrode plate, its substrate coated with the bonding element (typically an intermediate layer of nanoparticles of the electrode material to which this intermediate layer is to be welded), the second electrode plate of the same polarity as the first, the solid electrolyte (separator), the electrode plate of opposite polarity, its substrate coated with the bonding element (typically an intermediate layer of nanoparticles of the electrode material to which this intermediate layer is to be bonded), and so on. The final thermocompression is them carried out which is used both to weld the electrodes together on the solid electrolyte and to weld the electrode plate to the current collectors.

In the two variants presented above, the thermocompression welding is performed at a relatively low temperature, which is possible due to the very small size of the nanoparticles. As a result, there is no oxidation of the metal layers of the substrate.

If the electrode layers or plates (it should be noted that the term “electrode plate”, the term “plate” includes “sheets”) show sufficient electronic conductivity, a separate current collector may not be required. This variant is mainly used for microbatteries and intermediate-power batteries, and does not represent a preferred embodiment for batteries with a power rating greater than 1 mA h. In other embodiments of the assembly, which are described below, a conductive adhesive (loaded with graphite) or a sol-gel deposit loaded with conductive particles is used, or metal strips, preferably with a low melting point (for example aluminium); during thermomechanical treatment (thermopressing) the metal foil can be deformed by flowing and can be used to form this join between the plates.

A second object of the invention is a porous anode for a lithium-ion battery designed to have a capacity greater than 1 mA h, comprising a porous layer with a porosity of between 25% and 50% by volume, preferably of between 28% and 43% by volume, and even more preferably of between 30% and 40% by volume, characterised in that said porous layer comprises:
pores with an average diameter of less than 50 nm,
a porous network of a material A, comprising optionally on and inside the pores forming said porous network a coating of an electronically conductive material, and characterised in that said material A is selected from niobium oxides and mixed oxides of niobium with titanium, germanium, cerium, lanthanum, copper or tungsten, and preferably in the group formed by:
Nb₂O_{5-δ}, Nb₁₈W₁₆O_{93-δ}, Nb₁₆W₅O_{55-δ} with 0≤x<1 and 0≤δ≤2
TiNb₂O_{7-δ}, Ti₁₋ₓM¹ₓNb_{2-y}M²_{y}O_{7-δ}, Li_{w}Ti₁₋ₓM¹ₓNb_{2-y}M²_{y}O_{7-δ} wherein M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn, wherein M¹ and M² can be identical or different from one another, and wherein 0≤w≤5 and 0≤x≤1 and 0≤y≤2 and 0≤δ≤0.3;
Ti₁₋ₓM¹ₓNb_{2-y}M²_{y}O_{7-z}M³_{z}, Li_{w}Ti₁₋ₓM¹ₓNb_{2-y}M²_{y}O_{7-z}M³_{z} wherein
   M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn,
   M¹ and M² can be identical or different from one another,
   M³ is at least one halogen,
   and wherein 0≤w≤5 and 0≤x≤1 and 0≤y≤2 and z≤0.3;
TiNb₂O_{7-z}M³_{z}, Li_{w}TiNb₂O_{7-z}M³_{z} wherein M³ is at least one halogen, preferably selected from F, Cl, Br, I or a mixture thereof, and 0<z≤0.3,
Ti₁₋ₓGeₓNb_{2-y}M¹_{y}O_{7-z}, Li_{w}Ti₁₋ₓGeₓNb_{2-y}M¹_{y}O_{7-z}, Ti₁₋ₓCeₓNb_{2-y}M¹_{y}O_{7-z}, Li_{w}Ti₁₋ₓCeₓNb_{2-y}M¹_{y}O_{7-z} wherein
   M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn;
   0≤w≤5 and 0≤x≤1 and 0≤y≤2 and z<1, preferably wherein 0≤w≤5 and 0≤x≤1 and 0≤y≤2 and z≤0.3 (preferably with z<0.3);
Ti₁₋ₓGeₓNb_{2-y}M¹_{y}O_{7-z}M²z, Li_{w}Ti₁₋ₓGeₓNb_{2-y}M¹_{y}O_{7-z}M²z, Ti₁₋ₓLaₓNb_{2-y}M¹_{y}O_{7-z}M²z, Li_{w}Ti₁₋ₓLaₓNb_{2-y}M¹_{y}O_{7-z}M²z, Ti₁₋ₓCuₓNb_{2-y}M¹_{y}O_{7-z}M²z, Li_{w}Ti₁₋ₓCuₓNb_{2-y}M¹_{y}O_{7-z}M²z, Ti₁₋ₓCeₓNb_{2-y}M¹_{y}O_{7-z} M²z, Li_{w}Ti₁₋ₓCeₓNb_{2-y}M¹_{y}O_{7-z}M²z, wherein
   M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
   M¹ and M² can be identical or different from one another,
   and wherein 0≤w≤5 and 0≤x≤1 and 0≤y≤2 and z≤0.3;
      said anode being obtainable by the method according to the invention.

A third object is a method for manufacturing a battery, preferably a lithium-ion battery, by implementing the method for manufacturing a porous anode according to the invention, or using a porous anode according to the invention.

Such a method is a method for manufacturing a battery, comprising at least one porous anode according to the invention, at least one separator and at least one porous cathode, characterised in that:
(a) a first substrate is provided, a second substrate, and
   a first colloidal suspension or a paste comprising aggregates or agglomerates of monodisperse primary nanoparticles of at least one active material of anode A is provided, with an average primary diameter D₅₀ of between 2 and 100 nm, preferably of between 2 and 60 nm, said aggregates or agglomerates having an average diameter D₅₀ of between 50 nm and 300 nm (preferably of between 100 nm and 200 nm),
it being understood that said material A is selected from niobium oxides and mixed oxides of niobium with titanium, germanium, cerium, lanthanum, copper, or tungsten, and preferably in the group formed by:
   Nb₂O_{5-δ}, Nb₁₈W₁₆O_{93-δ}, Nb₁₆W₅O_{55-δ} with 0≤x<1 and 0≤δ≤2;
   TiNb₂O_{7-δ}, Ti₁₋ₓM¹ₓNb_{2-y}M²_{y}O_{7-δ}, Li_{w}Ti₁₋ₓM¹ₓNb_{2-y}M²_{y}O₇ wherein M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn, wherein M¹ and M² which can be identical or different from one another, and wherein 0≤w≤5 and 0≤x≤1 and 0≤y≤2 and 0≤δ≤0.3;
   Ti₁₋ₓM¹ₓNb_{2-y}M²_{y}O_{7-z}M³_{z}, Li_{w}Ti₁₋ₓM¹ₓNb_{2-y}M²_{y}O_{7-z}M³_{z} wherein
      M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn,
      M¹ and M² can be identical or different from one another,
      M³ is at least one halogen,
      and wherein 0≤w≤5 and 0≤x≤1 and 0≤y≤2 and z≤0.3;
   TiNb₂O_{7-z}M³_{z}, Li_{w}TiNb₂O_{7-z}M³_{z} wherein M³ is at least one halogen, preferably selected from F, Cl, Br, I or a mixture thereof, and 0<z≤0.3,
   Ti₁₋ₓGeₓNb_{2-y}M¹_{y}O_{7-z}, Li_{w}Ti₁₋ₓGeₓNb_{2-y}M¹_{y}O_{7-z}, Ti₁₋ₓCeₓNb_{2-y}M¹_{y}O_{7-z}, Li_{w}Ti₁₋ₓCeₓNb_{2-y}M¹_{y}O_{7-z} wherein
      M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
      and wherein 0≤w≤5 and 0≤x≤1 and 0≤y≤2 and z<1, preferably wherein 0≤w≤5 and 0≤x≤1 and 0≤y≤2 and z<0.3;
   Ti₁₋ₓGeₓNb_{2-y}M¹_{y}O_{7-z}M²_{z}, Li_{w}Ti₁₋ₓGeₓNb_{2-y}M¹_{y}O_{7-z}M²_{z}, Ti₁₋ₓLaₓNb_{2-y}M¹_{y}O_{7-z}M²_{z}, Li_{w}Ti₁₋ₓLaₓNb_{2-y}M¹_{y}O_{7-z}M²_{z}, Ti₁₋ₓCuₓNb_{2-y}M¹_{y}O_{7-z}M²_{z}, Li_{w}Ti₁₋ₓCuₓNb_{2-y}M¹_{y}O_{7-z}M²_{z}, Ti₁₋ₓCeₓNb_{2-y}M¹O_{7-z}M²_{z}, Li_{w}Ti₁₋ₓCeₓNb_{2-y}M¹_{y}O_{7-z}M²_{z} wherein
      M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
      M¹ and M² which can be identical or different from one another,
      and wherein 0≤w≤5 and 0≤x≤1 and 0≤y≤2 and z≤0.3;
knowing that said first and/or said second substrate may be a substrate capable of acting as an electrical current collector, or an intermediate substrate,
   a second colloidal suspension is provided comprising aggregates or agglomerates of monodisperse primary nanoparticles of at least one cathode active material C, with an average primary diameter D₅₀ of between 2 nm and 100 nm, preferably of between 2 nm and 60 nm, said aggregates or agglomerates having an average diameter D₅₀ of between 50 nm and 300 nm (preferably of between 100 nm and 200 nm), and
   a third colloidal suspension is provided comprising aggregates or agglomerates of nanoparticles of at least one inorganic material E (which is preferably an electrical insulator), with an average primary diameter D₅₀ of between 2 nm and 100 nm, preferably of between 2 nm and 60 nm, said aggregates or agglomerates having an average diameter D₅₀ of between 50 nm and 300 nm (preferably of between 100 nm and 200 nm);
(b) depositing on at least one face of said first substrate an anode layer from said first colloidal suspension provided in step (a), and depositing on at least one face of said second substrate a cathode layer from said second colloidal suspension provided in step (a), by a method selected preferably from the group consisting of: electrophoresis, extrusion, a printing method, preferably selected from inkjet printing and flexographic printing, and a coating method, preferably selected from roll coating, curtain coating, doctor blade coating, coating by extrusion through a slot die, dip coating;
(c) said anode and cathode layers obtained in step (b) are dried, if necessary after having separated said layer from its intermediate substrate, and each layer is consolidated, by pressing and/or heating, to obtain respectively a porous, preferably mesoporous and inorganic, anode layer, and a porous, preferably mesoporous and inorganic, cathode layer;
(d) optionally, a coating of an electronically conductive material is deposited on and inside the pores of said porous anode and/or cathode layers, also as to form said porous anodes and porous cathodes;
(e) on said porous anode and/or said porous cathode obtained in step (c) or (d), a porous inorganic layer from the third colloidal suspension provided in step (a) is deposited by a technique selected from the group including: electrophoresis, extrusion, a printing method, preferably selected from inkjet printing and flexographic printing, and a coating method, preferably selected from roll coating, curtain coating, doctor blade coating, coating by extrusion through a slot die, dip coating;
(f) said porous inorganic layer of the structure obtained in step (e) is dried, preferably under a flow of air, and a heat treatment is carried out at a temperature above 130° C. and preferably between about 300° C. and about 600° C., knowing that if necessary the layer separated from its intermediate substrate is pressed onto a metal sheet capable of acting as a current collector, before performing said thermal treatment;
(g) the porous anode obtained in step d) or e) is successively stacked face-to-face with the porous cathode obtained in step d) or e), it being understood that the stack obtained comprises at least one porous inorganic layer as obtained in step e) forming said separator;
(h) the stack obtained in step (g) is subjected to thermocompression treatment at a temperature of between 120° C. and 600° C. in order to obtain a battery comprising at least one porous anode, at least one separator and at least one porous cathode.

The heat treatment in step (h) is performed after the deposit on the electrodes of the film separator. The product from step (h) can then be impregnated by an ionic conducting polymer or a polymer which has been made ionically conductive, or even by a liquid electrolyte containing at least one lithium salt, which are advantageously selected from a group formed by:
an electrolyte composed of at least one aprotic solvent and at least one lithium salt;
an electrolyte composed of at least one ionic liquid and at least one lithium salt;
a mixture of at least one aprotic solvent and at least one ionic liquid and at least one lithium salt;
a polymer made ionically conductive by the addition of at least one lithium salt; and
a polymer made ionically conductive by the addition of a liquid electrolyte, either in the polymer phase or in the mesoporous structure.

These manufacturing methods allow the production of fully solid batteries with fine and ceramic separators. These separators are impregnated very well with ionic liquids and are resistant to high temperatures.

A further object of the invention is a lithium-ion battery having a capacity greater than 1 mA h, which can be obtained by the method according to the invention. In this case, the battery comprises an anode according to the invention or which can be obtained by the method according to the invention. This anode advantageously has a mass capacity greater than 200 mAh/g, and preferably greater than 250 mAh/g.

A final object of the invention is the use of a battery according to the invention at a temperature lower than −10° C. and/or at a temperature higher than 50° C., and preferably at a temperature lower than −20° C. and/or at a temperature higher than 60° C., and even more preferably at a temperature lower than −30° C. and/or at a temperature higher than 70° C. In an advantageous embodiment of the invention, the battery has a lower surface capacity of the anodes than of the cathodes; this improves the temperature stability of the battery.

In a general manner, there are many problems associated with making fully solid, sintered and multilayer structures. This requires heating to high temperatures to perform the sintering, which may degrade the electrode materials and cause interdiffusion at the interfaces. According to one of its essential features the method according to the invention uses nanoparticles, which makes it possible to reduce the sintering temperature. Furthermore, advantageously partial sintering can be carried out to obtain mesoporous structures. In addition, this sintering may be performed on the electrode layers or plates before assembly with the separator, which avoids the presence of ceramic layers of different materials in contact during sintering. For the separator, it is advantageous to select a material with a relatively low melting point and which is inert to the contact of the electrodes in order to be able to carry out this assembly at a relatively low temperature.

### BRIEF DESCRIPTION OF THE DRAWING

FIG. 1 shows a discharge curve obtained with a Ti_{0.95}Ge_{0.05}Nb₂O₇ anode according to the invention, for two different regimes.

### DETAILED DESCRIPTION

### 1. Definitions

In the context of the present document, the size of a particle is defined by its largest dimension. A “nanoparticle” is defined as any particle or object of nanometric size with at least one of its dimensions being lower than or equal to 100 nm.

In the context of the present document, the term “electronically conductive oxide” is defined as electronically conductive oxides and electronically semiconductive oxides.

In the context of the present document, an electronically insulating material or layer, preferably an electronically insulating and ionically conductive layer is a material or a layer with an electrical resistivity (resistance to the passage of electrons) greater than 105 Ω·cm. An “ionic liquid” refers to any liquid salt, capable of transporting electricity, differing from all molten salts by a melting temperature below 100° C. Some of these salts remain liquid at ambient temperature and do not solidify, even at very low temperatures. Such salts are referred to as “ionic liquids at ambient temperature”.

The term “mesoporous materials” refers to any solid which has pores within its structure, referred to as “mesopores” with an intermediate size between that of the micropores (width less than 2 nm) and that of macropores (width greater than 50 nm), namely a size of between 2 nm and 50 nm. This terminology corresponds to that adopted by the IUPAC (International Union for Pure and Applied Chemistry), which is a reference for a person skilled in the art. The term “nanopore” is therefore not used here, even if the mesopores as defined above have nanometric dimensions in the sense of the definition of nanoparticles, knowing that pores of a size smaller than that of the mesopores are referred to as “micropores” by the person skilled in the art.

A presentation of the concepts of porosity (and of the terminology explained above) is given in the article “Texture des materiaux pulverulents or poreux” (“Texture of powdered or porous materials”) by F. Rouquerol et al, published in the collection “Techniques de l'Ingénieur” (“Engineering techniques”), Analyse and Caractérisation, section P 1050; this article also describes techniques for characterising porosity, in particular the BET method. Within the meaning of the present invention, the term “mesoporous layer” refers to a layer which has mesopores. As explained below, in these layers, the mesopores contribute significantly to the total pore volume; this is reflected by the expression “Mesoporous layer with mesoporous porosity greater than X % by volume” used in the description below, where X % is preferably greater than 25%, preferentially greater than 30% and even more preferably between 30 and 50% of the total volume of the layer.

The term “aggregate” is used to denote, according to IUPAC definitions, a loosely bound assembly of primary particles. In the present case, these primary particles are nanoparticles with a diameter which can be determined by transmission electronic microscopy. An aggregate of aggregated primary nanoparticles can normally be destroyed (i.e. reduced to primary nanoparticles) in suspension in a liquid phase from the effect of ultrasound, according to a technique known to the person skilled in the art.

The term “agglomerate” is defined, according to IUPAC definitions, as a strongly bonded assembly of primary particles or aggregates.

Within the meaning of the present invention the term “electrolyte layer” refers to the layer within an electrochemical device, this device being capable of functioning according to its purpose. For example, in a case where said electrochemical device is a secondary lithium ion battery the term “electrolyte layer” denotes the “porous inorganic layer” impregnated with a carrier phase of lithium ions. The electrolyte layer is an ionic conductor, but it is electronically insulating.

Said porous inorganic layer in an electrochemical device is also referred to as a “separator” here, according to the terminology used by the person skilled in the art.

According to the invention, the “porous inorganic layer”, preferably mesoporous, can be deposited electrophoretically by the dip coating method, referred to in the following as “dip coating”, by the inkjet printing method, referred to in the following as “inkjet printing”, by “roll coating”, by “curtain coating” or “doctor blade coating”, and this from a suspension of nanoparticle aggregate or agglomerates, preferably from a concentrated suspension containing agglomerates of nanoparticles.

### 2. Preparation of Nanopowder Suspensions

In the context of the present invention, monodisperse crystallised nanopowders with a primary particle size of less than 100 nm are preferably used for the electrode and separator layers. This promotes necking between the primary particles (in agglomerated form or not) during the consolidation treatment. The consolidation can then take place at a relatively low temperature, knowing that where the primary particles are already in a crystallised stated, the purpose of this treatment is no longer to recrystallise the latter. For some chemical compositions, it is necessary to use specific synthesis methods to obtain populations of monodisperse crystallised nanoparticles.

Generally, TNO (TiNb₂O₇) type compositions have a very low electronic conductivity. In a battery, in order to deliver high power, the particles need to be very small. Furthermore, as explained below, it is advantageous for the mesoporous network to be coated with a thin layer of an electronically conductive material in order to compensate for this low electronic conductivity of the anode material; a thin layer of graphitic carbon is used for this purpose (and not diamond-like carbon).

It is known that TNO (TiNb₂O₇) type particles can be synthesised hydrothermally, with a dispersed size of between about 50 nm and about 300 nm; however it is difficult to control this size and the dispersion is broad. This synthesis leads to amorphous particles which then need to be crystallised by a heat treatment at high temperature, for example at about 1000° C. for about 30 minutes. During this crystallisation the particles can grow in in an uncontrolled manner which widens the dispersion in size. Alternatively, there are solid state synthesis methods, which also require high temperature treatment to homogenise the chemical composition.

In the context of the present invention it is preferred to use primary nanoparticles, agglomerated or not, with a size less than 100 nm, preferably less than 60 nm, and even more preferably less than 40 nm. Such nanoparticles can be obtained by different methods.

According to one method, salts, complexes or alcoholates (such as ethanolates) of the cations of metal elements entering the composition of the desired phase are mixed to obtain a perfectly homogenised distribution on an atomic scale, and polymers are used for fixing this distribution of molecules, ions or complexes comprising the metal element. These polymers are then removed by heat treatment and only leave inorganic constituents on the atomic scale for which a simple calcination at a relatively low temperature will make it possible to obtain the desired crystallised phase on the nanoparticle scale. It is possible to add organic materials which are able to outgas strongly during the heat treatment phases and which will contribute to obtaining mesoporous agglomerates.

An example of such synthesis is the “Pechini process”, a sol-gel type process in which the cations of the desired phase (in our case for example Nb, Ti and others) are complexed by an organic molecule (such as citric acid or EDTA (ethylenediaminetetraacetatic acid)) and introduced into a polymer matrix (for example a polyalcohol such as polyethylene glycol or polyvinyl alcohol). This results in a very homogenous distribution of complexed and diluted cations. Subsequently, the polymer and the complexing organic molecule are eliminated by pyrolysis, leading to the formation of target inorganic oxides. Calcination at about 700° C. makes it possible to obtain crystallised nanoparticles. The process makes it possible to adjust the size of the particles which then reduces the concentration of cations in the reduced polymer matrix.

As an example, to obtain a suspension of cathode material particles, a LiMn₂O₄ powder consisting of clusters of nanoparticles can be synthesised using the Pechini process described in the article “Synthesis and Electrochemical Studies of Spinel Phase LiMn₂O₄ Cathode Materials Prepared by the Pechini Process”, W. Liu, G. C. Farrington, F. Chaput, B. Dunn, J. Electrochem. Soc., vol. 143, No. 3, 1996. After the calcination step at 600° C., the powder contains clusters with a size typically of between 50 nm and 100 nm; the size of the primary nanoparticles, which are crystallised, is typically between 10 nm and 30 nm depending on the synthesis conditions.

A particularly preferred anode material is Li_{w}Ti₁₋ₓGeₓNb_{2-y}M¹_{y}O_{7-z}M³_{z} wherein M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn, and wherein 0≤w≤5, 0≤x≤1, 0≤y≤2 and z≤0.3. M³ is at least one halogen. Preferably 0<x≤1 and even more preferably 0.1≤x≤1 as the presence of germanium in the composition of the anode reduces the resistance of the battery and increases its power.

It is noted that the redox properties of germanium make it possible to obtain in this compound a lithium insertion behaviour almost identical to that of the analogue compound without germanium. Even if the redox potential of Ge⁴⁺/Ge³⁺ ions is slightly lower than that of the Ti⁴⁺/Ti³⁺ couple, this potential remains sufficiently high to avoid the deposition (plating) of lithium on recharging and makes it possible to increase the energy density of the anode. Other active anode materials A are particularly preferred; these are materials of the type Ti₁₋ₓGeₓNb_{2-y}M¹_{y}O_{7-z}M²z, Li_{w}Ti₁₋ₓGeₓNb_{2-y}M¹_{y}O_{7-z}M²_{z}, Ti₁₋ₓLaₓNb_{2-y}M¹_{y}O_{7-z}M²z, Li_{w}Ti₁₋ₓLaₓNb_{2-y}M¹_{y}O_{7-z}M²_{z}, Ti₁₋ₓCuₓNb_{2-y}M¹_{y}O_{7-z}M²z, Li_{w}Ti₁₋ₓCuₓNb_{2-y}M¹_{y}O_{7-z}M²z, Ti₁₋ₓCeₓNb_{2-y}M¹_{y}O_{7-z} M²z, Li_{w}Ti₁₋ₓCeₓNb_{2-y}M¹_{y}O_{7-z}M²z wherein
M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
M¹ and M² which can be identical or different from one another,
and wherein 0≤w≤5 and 0≤x≤1 and 0≤y≤2 and z≤0.3.

For each of these active materials of the anode, 0<x s 1 is preferred and even more preferably 0.1≤x≤1 as the presence of germanium, cerium, lanthanum or copper in the composition of the anode improves the cycling performance of the battery. With regard to Li_{w}Ti₁₋ₓCuₓNb_{2-y}M¹_{y}O_{7-z}M²_{z}, 0<x≤1 is preferred and even more preferably 0.1≤x≤1 as the presence of copper in this active material of the anode also makes it possible to increase the battery power. A battery having a mesoporous anode made from this material can be recharged very rapidly and has a very good volumetric energy density, greater than that obtained with a Li₄Ti₅O₁₂ anode according to the prior art.

According to the invention, the material of the cathode is advantageously selected from the group including: LiCoPO₄; LiMn_{1.5}Ni_{0.5}O₄; LiFeₓCo₁₋ₓPO₄ (where 0<x<1); LiNi_{1/x}Co_{1/y}Mn_{1/z}O₂ with x+y+z=10; Li_{1.2}Ni_{0.13}Mn_{0.54}Co_{0.13}O₂; LiMn_{1.5}Ni_{0.5-x}XₓO₄ where X is selected from Al, Fe, Cr, Co, Rh, Nd, Sc, Y, Lu, La, Ce, Pr, Pm, Sm, Eu, Gd, Tb, Dy, Ho, Er, Tm, Yb and where 0<x<0.1; LiNi_{0.8}Co_{0.15}Al_{0.05}O₂; Li₂MPO₄F (with M=Fe, Co, Ni or a mixture of these different elements); LiMPO₄F (with M=V, Fe, Ti or a mixture of these different elements); LiMSO₄F (with M=Fe, Co, Ni, Mn, Zn, Mg), LiNi_{1/x}Mn_{1/y}Co_{1/z}O₂ with x+y+z=10; LiCoO₂. For high-capacity cathodes in particular LiNi_{1/x}Mn_{1/y}Co_{1/z}O₂ with x+y+z=10, LiNi_{0.8}Co_{0.15}Al_{0.05}O₂, and LiCoO₂ are preferred. For example, LiNiₓMn_{y}Co_{z}O₂ (also known as NMC) can be used, preferably with x+y+z=1, and even more preferably with x:y:z=4:3:3 (material known as NMC433).

### 3. Deposition of the Layers and their Consolidation

In general, a layer of a nanoparticle suspension is deposited on a substrate by any suitable technique, and in particular by a method selected from the group including: electrophoresis, extrusion, a printing method and preferably inkjet printing or flexographic printing, a coating method and preferably by doctor blade coating, roll coating, curtain coating, dip coating or through a slot die. The suspension is typically in the form of an ink, i.e. a fairly fluid liquid, but can also have a paste-like consistency. The deposition technique and the deposition method has to be compatible with the viscosity of the suspension, and vice versa.

The deposited layer is then dried. The layer is then consolidated to obtain the desired ceramic mesoporous structure. This consolidation is described below. It comprises a heat treatment and possibly a thermomechanical treatment, typically thermocompression. During this thermomechanical treatment the electrode layer is freed from any organic constituents and residues (such as the liquid phase of the nanoparticle suspension and surfactant products): it becomes an inorganic (ceramic) layer. The consolidation of a plate is preferably carried out after its separation from its intermediate substrate, as the latter could be degraded during this treatment.

The deposit of the layers, their drying and consolidation are likely to raise certain problems which will now be discussed. These problems are partly related to the fact that during the consolidation of the layers shrinkage occurs which generates internal stresses.

According to a first embodiment, the electrode layers are each deposited on a substrate capable of acting as an electrical current collector. A metal sheet (i.e. a laminated metal sheet) is preferred for this purpose. Layers comprising the suspension of nanoparticles or nanoparticle agglomerates can be deposited on both sides by the deposition techniques indicated above.

When one wishes to increase the thickness of the electrodes it is observed that the shrinkage generated by the consolidation can lead either to the cracking of the layers, or to a shear stress at the interface between the substrate (which has a fixed dimension) and the ceramic electrode. When this shear stress exceeds a threshold level, the layer is detached from its substrate.

To avoid this phenomenon, it is preferable to increase the thickness of the electrodes by a succession of deposition-sintering operations. This first variant of the first embodiment of depositing the layers gives a good result, but is not very productive. Alternatively, in a second variant, layers with a greater thickness are deposited on both sides of a perforated substrate. The perforations need to have a sufficient diameter so that the two layers on the front and back are in contact at the perforations. Thus, during the consolidation, the nanoparticles and/or agglomerates of nanoparticles of electrode material in contact through the perforations in the substrate weld together, forming an attachment point (welding point between the deposits on both sides). This limits the loss of adherence of the layers to the substrate during the consolidation steps.

According to a second embodiment, the electrode layers are not deposited on a substrate capable of acting as an electrical current collector, but on a temporary, intermediate substrate. In particular, fairly thick layers (green sheets) can be deposited from suspensions that are more concentrated in nanoparticles and/or nanoparticles agglomerates (i.e. less fluid, preferably paste-like). These thick layers are deposited for example by a coating method, with reference to doctor blade or tape casting technique. Said intermediate substrate may be a polymer sheet, for example polyethylene terephthalate, abbreviated to PET. During the drying, these layers do not crack. For consolidation by heat treatment (and preferably already for drying them) they can be detached from their substrate; resulting in so-called “green” electrode plates which after calcination heat treatment and partial sintering become self-supporting, mesoporous ceramic plates.

A three-layer stack is then formed, namely two electrode plates with the same polarity separated by a metal sheet capable of acting as an electric current collector. This stack is then assembled by a thermomechanical treatment, comprising pressing and a heat treatment, preferably simultaneously. In one variant, to facilitate the bonding between the ceramic plates and the metal sheet, the interface may be coated with a layer enabling electronic conductive bonding. This layer may be a sol-gel layer (preferably of the type that allows the chemical composition of electrodes to be achieved after heat treatment) possibly charged with particles of an electronically conductive material, which will make a ceramic bond between the mesoporous electrode and the metal sheet. This layer may also be formed by a thin layer of unsintered electrode nanoparticles, or a thin layer of a conductive adhesive (charged with graphite particles for example), or even a metal layer of a metal with a low melting point.

Said metal sheet is preferably a laminated sheet, i.e. obtained by laminating. The laminating may optionally be followed by a final annealing, which may be a softening (total or partial) or recrystallization annealing, according to the terminology of metallurgy. It is also possible to use an electrochemically deposited sheet, for example an electroplated copper sheet or an electroplated nickel sheet.

In any case, a mesoporous ceramic electrode is obtained, without organic binder, located on either side of a metal substrate used as an electronic current collector. In one variant of the method according to the invention, batteries are made without using metal current collectors. This is possible in the case where the electrode plates are sufficiently electronically conductive to ensure the passage of electrons over the ends of the electrodes. Sufficient electronic conductivity can be observed either in the case where the electrode material has intrinsically very high electronic conductivity (in the case of materials such as LiCoO₂ or Nb₁₆W₅O₅₅), or in the case where the mesoporous surface has been coated with an electronically conductive layer.

### 4. Deposit of the Thin Layer of an Electronic Conductor

This step is optional. Indeed, depending on the desired power of the electrode (which also influences its thickness) and the conductivity of the electrode materials it may or may not be necessary to carry out this treatment to improve the conductivity of the electrode. For example, TNO (Titanium Niobium Oxide) is generally less conductive than NWO (Niobium Tungsten Oxide), and it is therefore an anode layer of NWO which for the same thickness will need more of this deposit of a thin electronically conductive film. Likewise, for the same material, thicker electrode layers will need more of this electronically conductive thin film than thin electrode layers.

The anode materials (more particularly titanium oxides, niobium oxides and mixed oxides of titanium and niobium, and in particular TiNb₂O₇ abbreviated to TNO) and cathode materials used in the context of the present invention are poor electronic conductors. A battery containing them would therefore have a high series resistance, which implies an ohmic loss of energy, and all the more so as the electrodes are thick. According to the invention a nanolayer of an electronically conductive material is deposited in the mesoporosity network, i.e. inside the pores, to guarantee a good electronic conductivity of the electrodes. This need to increase the conductivity is greater the thicker the deposits. It is thus possible to have thick electrodes with high power which have a low series resistance.

To address this problem, according to an optional feature of the present invention, a coating of an electronically conductive material is deposited on and within the pores of said porous layer of anode material. Indeed, as explained above, during the consolidation of the layer anode material, the anode material nanoparticles naturally “weld” together naturally to generate a porous, rigid, three-dimensional structure, without any organic binder; this porous layer, preferably a mesoporous layer, is perfectly suited to the application of a surface treatment, by gaseous or liquid means, which penetrates the depth of the open porous structure of the layer.

In a very advantageous manner this deposition, if carried out, is carried out by a technique allowing a coating (also referred to as “conformal deposition”), i.e. a deposition which faithfully reproduces the atomic topography of the substrate on which it is applied, which penetrates deeply into the open porosity network of the layer. Said electronically conductive material may be carbon.

ALD techniques (Atomic Layer Deposition) or CSD (Chemical Solution Deposition), known as such, may be suitable. They may be applied to the electrodes after manufacture, before and/or after the deposit of separator particles and before and/or after the assembly of the cell. The ALD deposition technique is performed layer-by-layer, by a cyclical method, and makes it possible to form a coating which closely reproduces the topography of the substrate; the coating covers the whole surface of the electrodes. This coating typically has a thickness of between 1 nm and 5 nm.

The deposition by ALD is performed at a temperature typically between 100° C. and 300° C. It is important that the layers are free of organic materials: they must not contain any organic binder, any residues of stabilising binders used to stabilise the suspension have to have been removed by purification of the suspension and/or during the heat treatment of the layer after drying. Indeed, at the temperature of the ALD deposition, the organic materials forming the organic binder (for example the polymers contained in the ink tape casting electrodes) are at risk of decomposing and polluting the ALD reactor. Furthermore, the presence of residual polymers in contact with the electrode active material particles may prevent the ALD coating from coating the entirety of the particle surfaces, which reduces its effectiveness.

The technique of CSD deposition also makes it possible to form a coating with a precursor of the electronically conductive material which faithfully reproduces the topography of the substrate; it covers the entire surface of the electrodes. This coating typically has a thickness of less than 5 nm, preferably between 1 nm and 5 nm. It then has to be transformed into electronically conductive material. In the case of a carbon precursor this is done by pyrolysis, preferably in insert gas (such as nitrogen).

A layer of an electronically conductive material can be formed, in a very advantageous manner, by immersion in a liquid phase comprising a precursor of said electronically conductive material followed by the transformation of said precursor of an electronically conductive material into an electronically conductive material by heat treatment. This method is simple, fast, easy to implement and is less expensive than the ALD atomic layer deposition technique. Advantageously, said precursor of the electronically conductive material is selected from organic salts containing one or more metal elements which are capable, after heat treatment such as calcination preferably carried out in air or in an oxidising atmosphere, of forming an electronic conductive oxide. These metal elements, preferably metal cations, may advantageously be selected from tin, zinc, indium, gallium or a mixture of two or three or four of these elements. The organic salts are preferably selected from an alcoholate of at least one metal cation capable, after heat treatment such as calcination preferably performed in air or in an oxidising atmosphere, of forming an electronically conductive oxide, an oxalate of at least one metal cation which is capable, after heat treatment such as calcination preferably performed in air or in an oxidising atmosphere, of forming an electronically conductive oxide and an acetate of at least one metal cation which is capable, after heat treatment such as calcination preferably performed in air or in an oxidising atmosphere, of forming an electronically conductive oxide.

Advantageously, said electronically conductive material may be an electronically conductive oxide material, preferably selected from:
tin oxide (SnO₂), zinc oxide (ZnO), indium oxide (In₂O₃), gallium oxide (Ga₂O₃), a mixture of two of these oxides such as indium-tin oxide corresponding to a mixture of indium oxide (In₂O₃) and tin oxide (SnO₂), a mixture of three of these oxides or a mixture of four of these oxides,
doped oxides based on zinc oxide, the doping being preferably with gallium (Ga) and/or aluminium (AI) and/or boron (B) and/or beryllium (Be), and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped oxides based on indium oxide, the doping being preferably with tin (Sn), and/or gallium (Ga) and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped tin oxides, the doping being preferably with arsenic (As) and/or fluorine (F) and/or nitrogen (N) and/or niobium (Nb) and/or phosphorus (P) and/or antimony (Sb) and/or aluminium (AI) and/or titanium (Ti), and/or gallium (Ga) and/or chromium (Cr) and/or cerium (Ce) and/or indium (In) and/or cobalt (Co) and/or nickel (Ni) and/or copper (Cu) and/or manganese (Mn) and/or germanium (Ge).

To obtain a layer of an electronically conductive material, preferably an electronically conductive oxide material, from an alcoholate, an oxalate or an acetate, the porous layer may be immersed in a rich solution of the desired electronically conductive material precursor. Then, the electrode is dried and subjected to a heat treatment, preferably in air or an oxidising atmosphere, at a temperature sufficient to pyrolysis the precursor of the electronically conductive material of interest. Thus, a coating is formed of the electronically conductive material, preferably a coating of an electronically conductive oxide material, more preferably made of SnO₂, ZnO, In₂O₃, Ga₂O₃, or indium oxide-tin, over the whole internal surface of the electrode, perfectly distributed.

The presence of an electronically conductive coating in the form of an oxide in place of a carbon coating on and within the pores of the porous layer gives the electrode better electrochemical performance at high temperatures and significantly increases the stability of the electrode. The fact of using an electronically conductive coating in the form of an oxide instead of a carbon coating gives, among other things, better electronic conduction to the final electrode. Indeed, the presence of this electronically conductive oxide layer on and within the pores of the porous layer or plate, particularly due to the fact that the electrically conductive coating is in the form of an oxide, makes it possible to improve the final properties of the electrode, in particular to improve the voltage resistance of the electrode, its temperature resistance during sintering, and improve the electrochemical stability of the electrode, particularly when it is in contact with an electrolyte liquid, to reduce the polarisation resistance of the electrode, even when the electrode is thick. It is particularly advantageous to use an electronically conductive coating in the form of an oxide, in particular of the type In₂O₃, SnO₂, ZnO, Ga₂O₃ or a mixture of one or more of these oxides, on and inside the pores of the porous layer of an electrode active material, when the electrode is thick, and/or the active materials of the porous layer are too resistant.

The electrode according to the invention is porous, preferably mesoporous and has a large specific surface area. The increase in the specific surface area of the electrode multiplies the exchange surfaces, and consequently the power of the battery, but it also accelerates the parasitic reactions. The presence of these electronically conductive coatings in the form of oxides on and within the pores of the porous layer will block these parasitic reactions.

Furthermore, due to the very large specific surface area, the effect of these electronically conductive coatings on the electronic conductivity of the electrode will be much more pronounced than in the case of a conventional electrode, where the specific surface is smaller, even if the deposited conductive coatings are thin. These electronically conductive coatings, deposited on and inside the pores of the porous layer give the electrode excellent electronic conductivity. It is essentially the synergistic combination of a porous layer or plate made from an electrode active material, and an electronically conductive coating in the form of an oxide disposed on and within the pores of said porous layer or plate which allows the final properties of the electrode to be improved, in particular to obtain thick electrodes without increasing the internal resistance of the electrode.

Furthermore, the electronically conductive coating in the form of an oxide on and within the pores of a porous layer is easier and cheaper to achieve than a carbon coating. Indeed, in the case of electronically conductive material coatings in the form of oxide, the transformation of the precursor of the electronically conductive material into the electronic conductive coating does not need to be carried out in an inert atmosphere, unlike the case of a carbon coating.

In this variant of depositing a nanolayer of electronically conductive material, it is preferable that the diameter D₅₀ of the primary particles of electrode material is at least 10 nm so as to prevent the conductive layer from clogging the open porosity of the electrode layer. In the case of depositing self-supporting electrode plates, this treatment can be carried out on the mesoporous ceramic plate and prior to bonding to the current collectors.

### 5. Selection of the Materials of the Layers

To obtain high-performance batteries it is necessary to optimise their mass capacity and the voltage. This may mean there are limits in the choice of different materials which have to be compatible with one another and stable in the potential conditions in which the battery operates.

In this section the cathode materials will be discussed. The anode materials have been presented above, they are oxide formulations containing niobium. These anode materials have mass capacities greater than 160 mAh/g and lithium insertion voltages greater than 0.5V/Li, allowing rapid recharging without the risk of lithium plating. Furthermore, these anode materials used according to the invention do not have significant volume variations during the charging and discharging state, such that they can be used in fully solid-state cells.

With regard to the cathode materials, in the method for manufacturing a battery according to the invention, as presented in section “Object of the invention” above, in a first embodiment, when the porous cathode has a mass capacity>120 mAh/g and operates at a voltage<4.5V,
said cathode active material C is advantageously selected from the group formed by: LiCoO₂, LiNi_{1/x}Co_{1/y}Mn_{1/z}O₂ with x+y+z=10, Li_{1.2}Ni_{0.13}Mn_{0.54}Co_{0.13}O₂, LiNi_{0.8}Co_{0.15}Al_{0.05}O₂, Li₂FePO₄F, LiMSO₄F with M=Fe, Co, Ni, Mn, Zn, Mg or a mixture of these different elements,
said first and second substrates are selected from the group formed by the metals Cu, Al, stainless steels, Mo, W, Ta, Ti, Cr, Ni and alloys formed by at least one of these elements, knowing that if the cathode layer is a cathode plate initially deposited on an intermediate substrate and heat-treated after it has been separated from its initial substrate and before it is brought into contact with a substrate capable of acting as an electric current collector, said plate may be plated on a low-melting substrate, such as a sheet of aluminium, and the method is characterised more particularly in the following manner:
in step (i), between step (f) and step (g) the structure obtained after step (f), or, after step (h), said battery is impregnated by an electrolyte which is electrochemically stable up to at least 4.5V, selected from the group formed by:
   an electrolyte composed of at least one aprotic solvent and at least one lithium salt;
   an electrolyte composed of at least one ionic liquid and at least one lithium salt;
   a mixture of at least one aprotic solvent and at least one ionic liquid and at least one lithium salt;
   a polymer made ionically conductive by the addition of at least one lithium salt; and
   a polymer made ionically conductive by the addition of a liquid electrolyte, either in the polymer phase, or in the mesoporous structure,
and even more preferably, by an electrolyte selected from the group formed by:
   an electrolyte comprising N-butyl-N-methyl-pyrrolidinium 4,5-dicyano-2-(trifluoro methyl) imidazole (Pyr₁₄TDI) and containing lithium salts of type LiTDI,
an electrolyte comprising 1-methyl-3-propylimidazolium 4,5-dicyano-2-(trifluoro-methyl)imidazolide (PMIM-TDI) and 4,5-dicyano-2-(trifluoro-methyl)imidazolide of lithium (LiTDI).

The use of conductive adhesives or electronically deposited conductive layers deposited by a sol-gel method can protect the metal substrate against corrosion, and in this case first and/or second substrates made of less noble metals than mentioned, especially aluminium and copper can be used. The RTILs used are a combination of a cationic group and an anionic group. The cations are preferably selected from the group formed by the following cationic compounds and families of cationic compounds: imidazolium (such as the cation 1-pentyl-3-methylimidazolium, abbreviated to PMIM), ammonium, pyrrolidinum, and/or the anions are preferably selected from the group formed by the following anionic compounds and families of anionic compounds: bis(trifluoromethanesulfonyl)imide, bis(trifluorosulfonyl)imide, trifluoromethylsulfonate, tetra-fluoroborate, hexafluorophosphate, 4,5-dicyano-2-(trifluoromethyl)imidazolium (abbreviated to TDI), bis(oxlate)borate (abbreviated to BOB), oxalyldifluoroborate (abbreviated to DFOB), bis(mandelato)borate (abbreviated to BMB), bis(perfluoropinacolato) borate (abbreviated to BPFPB).

As explained in more detail below in the following section, in a second embodiment of this method, after step (h) in a step (i) said battery is impregnated with an electrolyte, preferably by a carrier phase of lithium ions, selected from the group formed by:
an electrolyte composed of at least one aprotic solvent and at least one lithium salt;
an electrolyte composed of at least one ionic liquid and at least one lithium salt;
an mixture of at least one aprotic solvent and at least one ionic liquid and at least one lithium salt;
a polymer made ionically conductive by the addition of at least one lithium salt; and
a polymer made ionically conductive by the addition of a liquid electrolyte, either in the polymer phase, or in the mesoporous structure, and even more preferably, by an electrolyte selected from the group formed by:
an electrolyte comprising N-butyl-N-methyl-pyrrolidinium 4,5-dicyano-2-(trifluoro methyl) imidazole (Pyr₁₄TDI) and containing lithium salts of type LiTDI,
an electrolyte comprising 1-methyl-3-propylimidazolium 4,5-dicyano-2-(trifluoro-methyl)imidazolide (PMIM-TDI) and 4,5-dicyano-2-(trifluoro-methyl)imidazolide of lithium (LiTDI).

The inorganic material E has to be an electronic insulator. Oxides such as Al₂O₃, ZrO₂, SiO₂, can be used or also phosphates or borates. Nanoparticles of this material E form the mesoporous electrolyte separator layer.

### 6. Impregnation by an Electrolyte Liquid to Form a Battery

After assembly of the stack of layers intended to form the battery, followed by thermocompression, the resulting assembly must be impregnated with an electrolyte to form a battery. Said electrolyte has to comprise a lithium ion carrier phase, as described in the preceding section. The impregnation may be performed in different steps of the method. The impregnation, especially with a liquid electrolyte, may be performed in particular on the stacked and thermocompressed cells, i.e. after the battery is finished. The impregnation, especially with a liquid electrolyte, can also be performed after encapsulation, starting from the cut edges.

The carrier phase of lithium ions may be an organic liquid containing lithium salts. The carrier phase of lithium ions may also be an ionic liquid (or a mixture of several ionic liquid) containing lithium salts, possibly diluted with an organic solvent or with a mixture of organic solvents containing a lithium salt which may be different from the latter or the mixture dissolved in the ionic liquid. The carrier phase of lithium ions may comprise a mixture of several ionic liquids. Ionic liquids that are liquid at ambient temperature (RTIL=Room Temperature Ionic Liquids) can be used.

Generally, the cations of this ionic liquid are preferably selected from the group formed by the following cationic compounds and families of cationic compounds: imidazolium (such as the cation 1-pentyl-3-methylimidazolium, abbreviated to PMIM), ammonium, pyrrolidinum, and/or the anions of this ionic liquid are preferably selected from the group formed by following anionic compounds and families of anionic compounds: bis(trifluoromethanesulfonyl)imide, bis(trifluorosulfonyl)imide, trifluoromethylsulfonate, tetra-fluoroborate, hexafluorophosphate, 4,5-dicyano-2-(trifluoromethyl)imidazolium (abbreviated to TDI), bis(oxlate)borate (abbreviated to BOB), oxalyldifluoroborate (abbreviated to DFOB), bis(mandelato)borate (abbreviated to BMB), bis(perfluoropinacolato) borate (abbreviated to BPFPB). The composition of the impregnation electrolyte and its concentration of lithium salts may be adjusted to respond to the requirements of the intended application of the battery in terms of temperature, power etc.

Thus, and by way of example, for a battery designed to operate at a high temperature RTIL-based electrolytes of the Pyr₁₄FSI or Pyr₁₄TFSI type with LiFSI and/or LiTFSI and/or LiTDI such as lithium salt are preferred. Solvents resistant to high temperatures, such as for example GBL, may be added at levels below 50%. Additives may also be added to these formulations in order to reduce parasitic reactions on the surface of the electrodes and/or on the surface of current collectors.

Advantageously, the carrier phase of lithium ions comprises at least one ionic liquid, preferably at least one ionic liquid at ambient temperature, such as PYR₁₄TFSI, optionally diluted in at least one solvent, such as γ-butyrolactone. The carrier phase of lithium ions may contain for example LiPF₆ or LiBF₄ dissolved in an aprotic solvent or an ionic liquid containing lithium salts. It is also possible to use ionic liquid, possibly dissolved in a suitable solvent, and/or mixed with organic electrolytes.

For example, LiPF₆ dissolved in EC/DMC can be mixed to 50% by mass with an ionic liquid containing lithium salts of the LiTFSI:PYR₁₄TFSI type (molar ratio 1:9). It is also possible to make mixtures of ionic liquids which operate at a low temperature such as for example the mixture LiTFSI:PYR₁₃FSI:PYR₁₄TFSI (molar ratio 2:9:9).

EC is the common abbreviation of ethylene carbonate (no CAS: 96-49-1). DMC is the common abbreviation for dimethyl carbonate (no CAS: 616-38-6). LITFSI is the common abbreviation for lithium bis-trifluoromethanesulfonimide (no CAS: 90076-65-6). PYR₁₃FSI is the common abbreviation for N-Propyl-N-Methylpyrrolidinium bis(fluorosulfonyl) imide. PYR₁₄TFSI is the common abbreviation for 1-butyl-1-methylpyrrolidinium bis(trifluoro-methanesulfonyl)imide.

The carrier phase of lithium ions may be an electrolyte solution comprising an ionic liquid. The ionic liquid is formed by a cation associated with an anion; this anion and this cation are selected such that the ionic liquid is in the liquid state in the operating temperature range of the battery. The ionic liquid has the advantage of having high thermal stability, low flammability, of being non-volatile, having low toxicity and good wettability of the ceramics, which are materials which can be used as electrode materials. In a surprising manner, the mass percentage of ionic liquid contained in the carrier phase of lithium ions may be greater than 50%, preferably greater than 60% and even more preferably greater than 70%, and this is contrary to the lithium-ion batteries of the prior art, where the mass percentage of ionic liquid in the electrolyte must be lower than 50% by mass so that the battery maintains a high capacity and voltage in discharge as well as a good cycling stability. Above 50% by mass the capacity of the battery of the prior art degrades, as indicated in application US 2010/209 783 A1. This may be explained by the presence of polymeric binders within the electrolyte of the battery of the prior art; these binders are weakly wetted by the ionic liquid inducing a poor ionic conduction within the carrier phase of lithium ions thus causing a degradation of the battery capacity.

PYR₁₄TFSI and LiTFSI can be used; these abbreviations are defined below. Advantageously, the ionic liquid may be a cation of the type 1-ethyl-3-methylimidazolium (also referred to as EMI⁺ or EMIM⁺) and/or n-propyl-n-methylpyrrolidinium (also referred to as PYR₁₃⁺) and/or n-butyl-n-methylpyrrolidinium (also referred to as PYR₁₄⁺), associated with bis (trifluoromethanesulfonyl)imide (TFSI⁻) anions and/or bis(fluorosulfonyl)imide (FSI⁻). In an advantageous embodiment the liquid electrolyte contains at least 50% by mass ionic liquid, which is preferably Pyr₁₄TFSI.

Other cations that can be used in these ionic liquids include PMIM⁺. Other anions that can be used in these ionic liquids include BF₄⁻, PF₆⁻, BOB⁻, DFOB⁻, BMB⁻, BPFPB⁻. To form an electrolyte, lithium salt such as LiTFSI may be dissolved in the ionic liquid which is used as a solvent or in a solvent such as γ-butyrolactone. The γ-butyrolactone prevents the crystallisation of the ionic liquids inducing a wider temperature operating range of the latter, especially at a low temperature. Advantageously, when the porous cathode comprise a lithiated phosphate, the carrier phase of lithium ions comprises a solid electrolyte such as LiBH₄ or a mixture of LiBH₄ with one or more compounds selected from LiCl, LiI and LiBr. LiBH₄ is a good conductor of lithium and has a low melting point making it easy to impregnate into porous electrodes, in particular by dipping. Due to its extremely reducing properties, LiBH₄ is not widely used as an electrolyte. The use of a protective film on the surface of the porous lithium phosphate electrode prevents the reduction of cathode materials by LiBH₄ and avoids its degradation.

As explained above, a number of ionic liquids can be used, in particular Pyr₁₄TFSI-LiTFSI and EMIM-TFSI. The latter is more fluid than Pyr₁₄-TFSI. The main difference between these two ionic liquids is the potential range of stability in which they can be used. EMIM-TFSI is stable from 1 V up to 4.7 V while Pyr₁₄-TFSI is stable from 0 V up to 5.0 V; for this reason Pyr₁₄-TFSI is preferred, despite its lower fluidity.

However, TFSI type lithium salts tend to corrode the substrates. For this reason, among the ionic liquids and associated salts, LiTDI is preferred instead of or in addition to LiTFSI as an anionic grouping of ionic liquid and/or lithium salts, when the cathode is operated at more than 4.3 V. It is observed that the simple addition of LiTDI-type salts to LiTFSI-type salts already decreases the corrosive effect of the ionic liquid compared to metal substrates. LiTFSI contains sulphur which tends to corrode the substrates, especially during operation at high temperature. LiTDI does not corrode substrates. TFSI may be used with substrates coated with a protective layer, or with substrates made of material which is more resistant to the corrosive action of TFSI; such substrates are Mo, W, Cr, Ti, Ta.

It is generally advantageous that the carrier phase of lithium ions comprises between 10% and 40% by mass of a solvent, preferably between 30 and 40% by mass of a solvent, and even more preferably between 30 and 40% by mass γ-butyrolactone, glyme or PC. In an advantageous embodiment the carrier phase of lithium ions comprises more than 50% by mass of at least one ionic liquid and less than 50% solvent, which limits the safety and ignition risk in the event of malfunctioning of batteries comprising such a lithium ion carrier phase.

Advantageously the carrier phase of lithium ions comprises:
a lithium salt or a mixture of lithium salts selected from the group including: LiTFSI, LiFSI, LiBOB, LiDFOB, LiBMB, LiBPFPB and LiTDI; the concentration of lithium salt is preferably between 0.5 mol/L and 4 mol/L; the applicant has found that the use of electrolyte with a sufficiently high concentration of lithium salts favours the performance of very rapid charging;
a solvent or a solvent mixture with a mass content of less than 40% and preferably less than or equal to 20%; this solvent may be for example γ-butyrolactone, PC, glymes;
optionally additives such as VC for stabilising the interfaces and limiting parasitic reactions.
   In another embodiment, the lithium ion carrier phase comprises:
between 30 and 40% by mass of a solvent, preferably between 30 and 40% by mass γ-butyrolactone, or PC or glyme, and
more than 50% by mass of at least one ionic liquid, preferably more than 50% by mass of PYR₁₄TFSI.

As an example, the lithium ion carrier phase may be an electrolyte solution comprising PYR₁₄TFSI, LiTFSI and γ-butyrolactone, preferably an electrolyte solution comprising about 90% by mass of PYR₁₄TFSI, 0.7 M LiTFSI, 2% LiTDI and 10% by mass of γ-butyrolactone.

### 7. Description of Advantageous Embodiments

Several embodiments of the battery according to the invention are described in the following. Generally, within the context of the present invention the electrodes may be mesoporous. They may be thick (typically between about ten micrometres and a hundred micrometres), and more particularly their thickness may be greater than 10 μm. They can be prepared by depositing agglomerates of nanoparticles. These agglomerates can have polydisperse sizes and/or two different sizes (bimodal granulometry). In the finished state these electrodes do not contain any binder (they may contain binders at the time of depositing the nanoparticle suspension or paste, but these binders will be eliminated during the calcination heat treatment). They are partially sintered, i.e. the primary nanoparticles, following the thermomechanical consolidation treatment, are welded together by the “necking” phenomenon (known to a person skilled in the art, see for example “Particulate Composites” by R. M. German, Springer International Publishing 2016, p. 26/27) to form a continuous three-dimensional mesoporous network.

The porous anode according to the invention advantageously has a mesoporosity of less than 50% and preferably between 20% and 45%, and preferably between 25% and less than 40%; a value of about 35% is suitable. Advantageously a nanolayer of an electronic conductor (for example carbon) is deposited on the mesoporous surface.

According to the invention, these mesoporous electrodes are coated with a layer of nanometric thickness (this thickness being typically between about 0.8 nm to 10 nm) which extends over their entire surface. Here the surface is not the geometrical surface of the layer but the whole of its mesoporous surface: the coating is also applied inside the pores. Said coating may be a conductive carbon coating.

After being coated with a conductive layer, this electrode is impregnated with a lithium-ion conductive phase. This phase may be liquid or solid. If it is solid, it may be organic or mineral.

This electrode is bonded and sintered onto a substrate resistant to high temperature heat treatments; said substrate can be for example made of W, Mo, Cr, Ti, and all alloys containing at least one of these elements. Stainless steel may be suitable. It should be noted that in the case where self-supporting electrode plates are prepared, this limit of the resistance of the substrate or current collector to oxidation at the heat treatment temperature of the electrode no longer exists, as at the time of the heat treatment the electrode is not yet in contact with its current collector.

The anode may be more particularly a TiNb₂O₇ anode (abbreviated to “TNO”), but the following description also relates to the other active materials of the anode. More particularly, a TiNb₂O₇ anode can be used with a mesoporous volume of about 35%. This anode is dimensioned for a capacity of about 230 mAh/g.

With these electrodes, and in particular with such a TiNb₂O₇ anode with a mesoporous volume of about 35% as described above, it is possible to make lithium-ion batteries. To enable the person skilled in the art to implement the invention we describe five embodiments, which in no way limit the scope of the invention.

In a first embodiment an attempt has been made to increase the energy of the battery, by choosing a cathode operating at high voltage. The cathode current collector is a sheet of Mo, W, Ta, Ti, Al, stainless steel, Cr or any alloy containing at least one of these elements; its thickness is typically between 5 μm and 20 μm. The cathode is made of LiCoPO₄ with a mesoporous volume of about 35%. The thickness of the cathode is about 90 μm; a nanolayer of an electronic conductor (in this case carbon) has been deposited on the mesoporous surface. This cathode is dimensioned for a capacity of about 145 mAh/g. The separator is a layer of Li₃PO₄ with a thickness of about 6 μm with a mesoporous volume of about 50%.

The anode current collector is a sheet of Mo, W, Ta, Ti, Cu, Cr, Ni, Al, stainless steel or any alloy containing at least one of these elements; its thickness is typically between 5 μm and 20 μm. In the second embodiment of the invention, where the anode was initially deposited on an intermediate substrate (one extruded), it is also possible to use an aluminium electrode for example. The TiNb₂O₇ anode with a mesoporous volume of about 35% had a thickness of about 50 μm.

In any case, and more particularly in the second embodiment of the invention (in which the anode is made in the form of a plate), the surface of the collector designed to be in contact with the electrode may be coated with a conductive coating, which in the case of the second embodiment of the invention, will also serve to form the bonding. The cell was impregnated with an RTIL-type ionic liquid (Room Temperature Ionic Liquid) formed by a mixture of Pyr14TFSI (1-butyl-1-methylpyrrolidinium bis(trifluoro-methylsulfonyl)imide; no CAS 223437-11-4) with 20% GBL and LiTFSI (lithium bis(trifluoromethanesulfonyl) imide; no CAS 90076-65-6; concentration of 0.7M).

The following mixture can also be used: LiTFSI 0.7M+Pyr₁₄TFSI+10% GBL+2% LiTDI. Such a battery achieves a volumetric capacity density of about 200 mAh/cm³ and a volumetric energy density of about 610 mWh/cm³. It can provide a continuous power of about 50 C. It can function in a very broad temperature range, typically between about −40° C. and about +60° C. There is no risk of thermal runaway. One of the disadvantages of this battery is the high cost of the cathode material, due to its high cobalt content.

In a second embodiment, the LiCoPO₄ cathode material was replaced by another high-voltage cathode material that does not contain cobalt, namely a spinel material, LiMn_{1.5}Ni_{0.5}O₄. It contains manganese, and for this reason the resistance of this cell at high temperature is slightly more limited than in the first embodiment.

The LiMn_{1.5}Ni_{0.5}O₄ cathode had a thickness of about 90 μm, a mesoporous volume of about 35%, with deposition of a carbon nanolayer; this cathode is sized for a capacity of about 120 mAh/g. The separator, the anode, the cathode and anode current collectors, as well as the ionic liquid used for the impregnation of the cell were the same as in the first embodiment.

This battery achieves a volumetric capacity density of 210 mAh/cm³ and a volumetric energy density of 625 mWh/cm³. It can deliver a continuous current of more than 50 C. It can operate in very broad temperature range, typically between about −40° C. and about +60° C. There is no risk of thermal runaway. These batteries are compatibles with fast charging; they can be recharged in less than 5 minutes without the risk of forming lithium precipitates.

In a third embodiment, a cathode operating at low voltage was used.

The cathode was made of Li_{1.2}Ni_{0.13}Mn_{0.54}Co_{0.13}O₂ with a thickness of about 90 μm and a mesoporous volume of about 35%, with deposit of a carbon nanolayer; this cathode is sized for a capacity of about 200 mAh/g. The separator is a layer of Li₃PO₄ with a thickness of about 6 μm with a mesoporous volume of about 50%.

The anode current collector is a sheet of Cu, Ni, W, Ta, Al, Cr, stainless steel, Ti, or Mo and any alloys comprising at least one of these elements; its thickness is typically between 5 μm and 20 μm. The TiNb₂O₇ anode with a mesoporous volume of about 35% had a thickness of about 80 μm; a carbon nanolayer was deposited on the mesoporous surface. The cell was impregnated with a RTIL-type ionic liquid, which consisted of a mixture of LiTDI and LiTFSI, and which was formed more precisely of Pyr14TFSI, with 0.7M LiTFSI and 2% LiTDI.

This battery achieves a volumetric capacity density of 285 mAh/cm³ and a volumetric energy density of 720 mWh/cm³. It can deliver a continuous current higher than 50 C. It can operate over a very wide temperature range, typically between about −40° C. and about +70° C. There is no risk of thermal runaway. These batteries are compatible with fast charging; they can be recharged in less than 5 minutes without the risk of forming lithium precipitates. It should be noted that this battery can operate in an extended temperature range (up to about +85° C.) when the cathode surface capacity is lower than the anode surface capacity.

A fourth embodiment relates to a high capacity microbattery with a cathode operating at low voltage.

The cathode current collector is a sheet of Mo, W, Ta, Ti, Al, stainless steels, Cr or any alloy containing at least one of these elements; its thickness is typically between 5 μm and 20 μm. It is possible to use a sheet of aluminium if the nanoparticles from which the cathode was made are already perfectly crystallised, or the collector is glued to the electrodes after sintering in the case where the electrode was made as an electrode plate.

The cathode was made of Li_{1.2}Ni_{0.13}Mn_{0.54}Co_{0.13}O₂ with a thickness of about 16 μm, a mesoporous volume of about 35%, with deposit of a carbon nanolayer; this cathode is dimensioned for a capacity of about 200 mAh/g. The separator is a Li₃PO₄ layer with a thickness of about 6 μm with a mesoporous volume of about 50%. The anode current collector is a sheet of Cu, Ni, Al or Mo; its thickness is typically between 5 μm and 20 μm. The TiNb₂O₇ anode with a mesoporous volume of about 35% has a thickness of about 14 μm; a carbon nanolayer was deposited on the mesoporous surface. The cell was impregnated with a RTIL-type ionic liquid, which consisted of Pyr14TFSI, with 0.7M LiTFSI and 2% LiTDI.

This microbattery achieves a volumetric capacity density of 215 mAh/cm³ and a volumetric energy density of 535 mWh/cm³. It can provide a continuous current higher than 50 C. It can operate over a very wide temperature range, typically between about −40° C. and about +70° C. There is no risk of thermal runaway. These batteries are also compatible with fast recharging. As indicated above, the operating temperature range can be extended to about +85° C. when the battery is sized so that the cathode surface capacity is lower than the anode surface capacity.

These battery cells and batteries have excellent performance at low temperatures. They are able to operate at temperatures below the crystallisation temperature of the liquid electrolyte. When the impregnation has been performed with a polymer, the conductive properties of the polymer are enhanced over a wide temperature range.

An advantageous battery according to the invention has a cathode current collector made from a material selected from the group formed by: Mo, Ti, W, Ta, Cr, Al, alloys based on the aforementioned elements, stainless steel; it also has a cathode with a pore volume of between 30 and 40%, which can be made of NMC, and preferably NMC₄₃₃, a conductive layer of carbon being deposited in the pores. Its separator is a mesoporous layer of Li₃PO₄, preferably having a thickness of between 6 μm and 8 μm. Its anode is a layer of TiNb₂O₇, preferably doped with a halide and/or cerium and/or germanium and/or lanthanum and/or copper, said layer being impregnated by a liquid electrolyte containing lithium salts. Its anode current collector is selected from a group formed by: Mo, Cu, Ni, alloys based on the aforementioned base elements, stainless steel. It is also possible to use aluminium. Other separator materials can be used.

The batteries according to the invention can be made with very different power ratings. In particular, by means of the method according to the invention it is possible to produce lithium-ion batteries with a capacity greater than 1 mA h. They are of particular interest in the form of high power batteries, especially for use in electric vehicles. With intermediate power ratings, they can be used in various nomadic electronic devices such as cell phones, laptops and portable reading devices. A battery with a capacity of no more than 1 mA h, is referred to here as a “microbattery”. For example, a cell of the fourth embodiment described above has been produced by multiplying the electrode thicknesses by a factor of six. Thus, with an anode thickness in the range of 50 μm to 80 μm, we obtain a battery with more than 550 Wh/1, operating over a very wide temperature range and capable of being recharged in less than 15 minutes. This battery is particularly well suited to the needs of hybrid vehicles and electric vehicles with fast recharging.

### EXAMPLES

In addition to very precise embodiments which were described in the section “Detailed description” above, further examples are given here to enable the person skilled in the art to reproduce the invention. These examples do not limit the invention.

### Example 1: Synthesis of TNO Nanopowders which can be Used to Make an Anode According to the Invention

A formulation of agglomerates of Ti_{0.95}Ge_{0.05}Nb₂O₇ nanoparticles was synthesised from the following alkoxides:
(i) Ge(OC₂H₅)₄, molar mass 252.88 g/mol, density 1.14 g/cm³;
(ii) Ti(OC₂H₅)₄, molar mass 228.11 g/mol, density 1.09 g/cm³;
(iii) Nb(OC₂H₅)₄, molar mass 318.21 g/mol, density 1.268 g/cm³.

In a first step, citric acid was dissolved in ethylene glycol by heating to 80° C. In parallel the mixture of ethoxides was prepared in a glove box, respecting the stoichiometry of the target component.

In a second step, the mixture of alkoxides was introduced under strong agitation into a citric acid/ethylene glycol solution at ambient temperature. The reaction mixture was stirred for 12h at 80° C. which resulted in the gelling of the solution.

The gel is then extracted to be placed in an alumina crucible. The crucibles are placed in a heating chamber at 250° C. for 12h. This heating step will enable the removal of excess ethylene glycol and activate the esterification reactions. The product is then calcined at 600° C. for 1 hour to remove a large proportion of the organic materials.

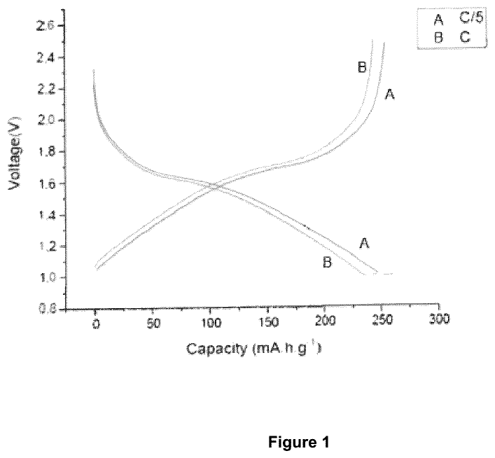

A second heat treatment is then carried out at 800° C. Agglomerates of nanoparticles (with elementary sizes of 40 nm) crystallised in the space group I2/m JCPDS: 39-1407 are then obtained. These are pure monoclinical crystals. FIG. 1 shows the electrochemical features of an anode prepared according to this example.

### Example 2: Manufacture of a Mesoporous Anode Plate According to the Invention

A slip was prepared consisting of agglomerates TNO nanoparticles. These agglomerates were about 100 nm in size and consisted of primary particles 15 nm in diameter.

These agglomerates of nanoparticles were integrated into a slip with the following composition (in percent by mass): 20% agglomerates of TNO nanoparticles, 36% 2-butanone and 24% ethanol acting as a solvent, 3% phosphoric ester acting as a dispersant, 8.5% dibutylphtalate acting as a plasticiser, 8.5% methacrylate resin acting as a binder.

This slip was cast in a strip, then cut into a plate and dried. These plates were then annealed at 600° C. for 1 hour in air to obtain the mesoporous ceramic plate which serves as an electrode. This plate was then impregnated by a glucose solution and annealed at 400° C. under N₂ so as to perform nanocoating of conductive carbon on the whole mesoporous surface of the electrode. These plates are very useful for the manufacturing of high-power batteries.

1. A method for manufacturing a porous anode for a battery comprising an anode, a separator and a cathode, wherein
said anode comprises a porous layer having a porosity between 25% and 50% by volume, and pores with an average diameter of less than 50 nm,
and wherein the manufacturing method comprises the following steps:
(a) providing a substrate and providing a colloidal suspension or a paste, the colloidal suspension or the paste including monodisperse primary nanoparticles of at least one active material of anode A,
the monodisperse primary nanoparticles being in the form of agglomerates or being dispersed,
the monodisperse primary nanoparticles having an average primary diameter D₅₀ of between 2 nm and 100 nm,
the colloidal suspension or the paste also comprises a liquid constituent,
the active material of anode A being selected from:
niobium oxides and mixed oxides of niobium with titanium, germanium, cerium, lanthanum, copper or tungsten, and preferably from the group formed by:
Nb₂O_{5-δ}, Nb₁₈W₁₆O_{93-δ}, Nb₁₆W₅O_{55-δ} with 0≤x<1 and 0≤δ≤2;
TiNb₂O_{7-δ}, Ti₁₋ₓM¹ₓNb_{2-y}M²_{y}O_{7-δ}, Li_{w}Ti₁₋ₓM¹ₓNb_{2-y}M²_{y}O₇ wherein M¹ and M² are each at least one element selected from the group consisting of; Nb, V, Ta, Fe, Co, Ti, Bi, Sb, As, P, Cr, Mo, W, B, Na, Mg, Ca, Ba, Pb, Al, Zr, Si, Sr, K, Cs and Sn, wherein M¹ and M² can be identical or different from one another, and wherein 0≤w≤5 and 0≤x≤1 and 0≤y≤2 and 0≤δ≤0.3;
Ti₁₋ₓM¹ₓNb_{2-y}M²_{y}O_{7-z}M³_{z}, Li_{w}Ti₁₋ₓM¹ₓNb_{2-y}M²_{y}O_{7-z}M³_{z} wherein:
M¹ and M² are each at least one element selected from the group consisting of; Nb, V, Ta, Fe, Co, Ti, Bi, Sb, As, P, Cr, Mo, W, B, Na, Mg, Ca, Ba, Pb, Al, Zr, Si, Sr, K, Cs and Sn,
M¹ and M² being identical or different from one another,
M³ is at least one halogen,
and wherein 0≤w≤5 and 0≤x≤1 and 0≤y≤2 and z≤0.3;
TiNb₂O_{7-z}M³_{z}, Li_{w}TiNb₂O_{7-z}M³_{z} wherein M³ is at least one halogen, preferably selected from: F, Cl, Br, I or a mixture thereof, and 0≤w≤5 and 0<z≤0.3;
Ti₁₋ₓGeₓNb_{2-y}M¹_{y}O_{7-z}, Li_{w}Ti₁₋ₓGeₓNb_{2-y}M¹_{y}O_{7-z}, Ti₁₋ₓLaₓNb_{2-y}M¹_{y}O_{7-z}, Li_{w}Ti₁₋ₓLaₓNb_{2-y}M¹_{y}O_{7-z}, Ti₁₋ₓCeₓNb_{2-y}M¹_{y}O_{7-z}, Li_{w}Ti₁₋ₓCeₓNb_{2-y}M¹_{y}O_{7-z} wherein;
M¹ is at least one element selected from the group consisting of; Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
and wherein 0≤w≤5 and 0≤x≤1 and 0≤y≤2 and z<1, preferably wherein 0≤w≤5 and 0≤x≤1 and 0≤y≤2 and z<0.3;
Ti₁₋ₓGeₓNb_{2-y}M¹_{y}O_{7-z}M²_{z}, Li_{w}Ti₁₋ₓGeₓNb_{2-y}M¹_{y}O_{7-z}M²_{z}, Ti₁₋ₓLaₓNb_{2-y}M¹_{y}O_{7-z}M²_{z}, Li_{w}Ti₁₋ₓLaₓNb_{2-y}M¹O_{7-z}M²_{z}, Ti₁₋ₓCuₓNb_{2-y}M¹_{y}O_{7-z}M²_{z}, Li_{w}Ti₁₋ₓCuₓNb_{2-y}M¹_{y}O_{7-z}M²_{z}, Ti₁₋ₓCeₓNb_{2-y}M¹_{y}O_{7-z}M²_{z}, Li_{w}Ti₁₋ₓCeₓNb_{2-y}M¹_{y}O_{7-z}M²_{z} wherein:
M¹ and M² are at least one element selected from the group consisting of; Nb, V, Ta, Fe, Co, Ti, Bi, Sb, As, P, Cr, Mo, W, B, Na, Mg, Ca, Ba, Pb, Al, Zr, Si, Sr, K, Cs and Sn;
0≤w≤5 and 0≤x≤1 and 0≤y≤2 and z≤0.3;
(b) depositing on at least one face of said substrate a layer from said colloidal suspension or paste provided in step (a), by a method selected from the group formed by:
electrophoresis;
extrusion;
a printing method, preferably inkjet printing or flexographic printing;
a coating method, preferably by doctor blade, roll coating, curtain coating, dip coating or coating through a slot die; and
(c) drying said layer obtained in step (b) and consolidating it by pressing and/or heating to obtain a porous layer.

2. The method according to claim 1, wherein the method is continued with step (d):
(d) depositing on and within the pores of said porous layer, a coating of an electronically conductive material, which is preferably selected from carbon or an electronically conductive oxide material.

3. The method according to claim 2, wherein the deposit of said coating of electronically conductive material is performed:
by atomic layer deposition ALD; or
by immersion in a liquid phase comprising a precursor of said electronically conductive material, followed by the transformation of said precursor into electronically conductive material.

4. The method according to claim 3, wherein said precursor is a carbon-rich compound, such as a carbohydrate, and wherein said transformation into electronically conductive material is done by pyrolysis, preferably in an insert atmosphere.

5. The method according to claim 24, wherein the organic salts are selected from:
an alcoholate of at least one metal element capable, after heat treatment such as calcination preferably performed in air or in an oxidising atmosphere, of forming an electronically conductive oxide;
an oxalate of at least one metal element capable, after heat treatment such as calcination preferably performed in air or in an oxidising atmosphere, of forming an electronically conductive oxide; and
an acetate of at least one metal element capable, after heat treatment such as calcination preferably performed in air or in an oxidising atmosphere, of forming an electronically conductive oxide;
and/or wherein in that the metal element is selected from: tin, zinc, indium, gallium or a mixture of two or three or four of these elements.

6. The method according to claim 1, said primary nanoparticles are in the form of aggregates or agglomerates, said aggregates or agglomerates having an average diameter D₅₀ between 50 nm and 300 nm.

7. The method according to claim 1, wherein said porous layer resulting from step (c) has a specific surface area of between 10 m²/g and 500 m²/g.

8. The method according to claim 1, wherein said layer obtained in step (c) has a thickness between 1 μm and 150 μm.

9. The method according to claim 1, wherein said substrate is an intermediate substrate, of which said layer is separated in step (c) after drying to form a porous anode plate.

10. A porous anode for a lithium-ion battery, comprising:
a porous layer with a porosity between 25% and 50% by volume,
and wherein said porous layer comprises:
pores with an average diameter of less than 50 nm,
a porous network of a material A, the porous network comprises on and within the pores forming said porous network a coating of an electronically conductive material,
and wherein said material A is selected from niobium oxides and mixed oxides of niobium with titanium, germanium, cerium, lanthanum, copper or tungsten.

11. The anode according to claim 10, wherein the electronically conductive material is selected from carbon, electronically conductive oxide materials, preferably selected from:
tin oxide (SnO₂), zinc oxide (ZnO), indium oxide (In₂O₃), gallium oxide (Ga₂O₃), a mixture of two of these oxides such as indium-tin oxide corresponding to a mixture of indium oxide (In₂O₃) and tin oxide (SnO₂), a mixture of three of these oxides or a mixture of four of these oxides,
doped oxides based on zinc oxide, the doping being preferably with gallium (Ga) and/or aluminium (AI) and/or boron (B) and/or beryllium (Be), and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped oxides based on indium oxide, the doping being preferably tin (Sn), and/or gallium (Ga) and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped tin oxides, the doping being preferably with arsenic (As) and/or fluorine (F) and/or nitrogen (N) and/or niobium (Nb) and/or phosphorus (P) and/or antimony (Sb) and/or aluminium (AI) and/or titanium (Ti), and/or gallium (Ga) and/or chromium (Cr) and/or cerium (Ce) and/or indium (In) and/or cobalt (Co) and/or nickel (Ni) and/or copper (Cu) and/or manganese (Mn) and/or germanium (Ge).

12. A method for manufacturing a battery, preferably a lithium-ion battery, using a porous anode according to claim 10.

13. A method according to claim 12, wherein the battery comprises at least one separator and at least one porous cathode, wherein:
(a) a first substrate, a second substrate are provided and
a first colloidal suspension or a paste comprising aggregates or agglomerates of monodisperse primary nanoparticles of at least one active material of anode A is provided, the monodisperse primary nanoparticles have an average primary diameter D₅₀ between 2 and 100 nm,
the aggregates or agglomerates have an average diameter D₅₀ of between 50 nm and 300 nm,
said material A is selected from niobium oxides and mixed oxides of niobium with titanium, germanium, cerium, lanthanum, copper or tungsten,
said first and/or said second substrate can be a substrate capable of acting as a collector of electric current, or an intermediate substrate,
a second colloidal suspension is provided comprising aggregates or agglomerates of monodisperse primary nanoparticles of at least one active material of cathode C,
the monodisperse primary nanoparticles have an average primary diameter D₅₀ of between 2 and 100 nm,
the aggregates or agglomerates have an average diameter D₅₀ of between 50 nm and 300 nm, and
a third colloidal suspension is provided comprising aggregates or agglomerates of nanoparticles of at least one inorganic material E,
the nanoparticles have an average primary diameter Do of between 2 nm and 100 nm
the aggregates or agglomerates have an average diameter D50 of between 50 nm and 300 nm;
(b) on at least one face of said first substrate an anode layer from said first colloidal suspension supplied in step (a) is deposited,
and on at least one face of said second substrate a cathode layer from said second colloidal suspension supplied in step (a) is deposited,
(c) said anode and cathode layers obtained in step (b) are dried,
the anode and cathode layers are optionally separated from the first and/or the second substrate acting as an intermediate substrate,
and each layer is consolidated by pressing and/or heating,
to obtain respectively;
a porous, preferably mesoporous and inorganic, anode layer, and
a porous, preferably mesoporous and inorganic, cathode layer;
(d) optionally, a coating of an electronically conductive material is deposited on and inside the pores of said porous anode and/or cathode layers, so as to form said porous anodes and porous cathodes;
(e) on said porous anode and/or said porous cathode obtained in step (d), a porous inorganic layer from the third colloidal suspension provided in step (a) is deposited by a technique selected from the group including:
electrophoresis;
extrusion;
a printing method, preferably selected from inkjet printing and flexographic printing; and
a coating method, preferably selected from roll coating, curtain coating, doctor blade coating, coating by extrusion through a slot die, dip coating;
(f) said porous inorganic layer of the structure obtained in step (e) is on the first and/or the second substrate acting as a current collector or is pressed onto a metal sheet capable of acting as a current collector when the layer has been separated from its intermediate layer,
the porous inorganic layer is dried, preferably under a flow of air, and a heat treatment is carried out at a temperature higher than 130° C. and preferably between about 300° C. and about 600° C.,
(g) the porous anode obtained in step d) or e) is successively stacked face-to-face with the porous cathode obtained in step d) or e), it being understood that the stack obtained comprises at least one porous inorganic layer as obtained in step e) forming said separator;
(h) the stack obtained in step (g) is subjected to a thermocompression treatment at a temperature between 120° C. and 600° C. in order to obtain a battery comprising at least one porous anode, at least one separator and at least one porous cathode.

14. The method according to claim 13, wherein said inorganic material E is an electrical insulator.

15. The method according to claim 13, wherein the product resulting from step (h) is impregnated with an electrolyte, preferably by a lithium ion carrier phase, selected from the group formed by:
an electrolyte composed of at least one aprotic solvent and at least one lithium salt;
an electrolyte composed of at least one ionic liquid and at least one lithium salt;
a mixture of at least one aprotic solvent and at least one ionic liquid and at least one lithium salt;
a polymer made ionically conductive by the addition of at least one lithium salt; and
a polymer made ionically conductive by the addition of a liquid electrolyte, either in the polymer phase or in the mesoporous structure,
and even more preferably, by an electrolyte selected from the group including:
an electrolyte comprising N-butyl-N-methyl-pyrrolidinium 4,5-dicyano-2-(trifluoromethyl) imidazole (Pyr₁₄TDI),
an electrolyte comprising 1-methyl-3-propylimidazolium 4,5-dicyano-2-(trifluoro-methyl)imidazolide (PMIM-TDI) and lithium 4,5-dicyano-2-(trifluoro-methyl)imidazolide (LiTDI).

16. The method according to claim 12, wherein said active material of cathode C is selected from the group formed by: LiCoPO₄, LiMn_{1.5}Ni_{0.5}O₄, LiFeₓCo₁₋ₓPO₄ and where 0<x<1, LiNi_{1/x}Co_{1/y}Mn_{1/z}O₂ with x+y+z=10, Li_{1.2}Ni_{0.13}Mn_{0.54}Co_{0.13}O₂, LiMn_{1.5}Ni_{0.5-x}XₓO₄ where X is selected from Al, Fe, Cr, Co, Rh, Nd, Sc, Y, Lu, La, Ce, Pr, Pm, Sm, Eu, Gd, Tb, Dy, Ho, Er, Tm, Yb and where 0<x<0.1, LiNi_{0.8}Co_{0.15}Al_{0.05}O₂, Li₂MPO₄F with M=Fe, Co, Ni or a mixture of these different elements, LiMPO₄F with M=V, Fe, T or a mixture of these different elements, LiMSO₄F with M=Fe, Co, Ni, Mn, Zn, Mg, LiCoO₂.

17. A lithium-ion battery comprising at least one porous anode, at least one separator and at least one porous cathode
wherein the porous anode comprises a porous layer with a porosity between 25% and 50% by volume,
said porous layer comprises:
pores with an average diameter of less than 50 nm,
a porous network of a material A, the porous network comprises on and within the pores forming said porous network a coating of an electronically conductive material,
said material A is selected from niobium oxides and mixed oxides of niobium with titanium, germanium, cerium, lanthanum, copper or tungsten,
the separator is a porous inorganic layer and is between the anode and the cathode.

18. The battery according to claim 17, wherein its electrolyte liquid contains at least 50% by mass ionic liquid, which is preferably Pyr₁₄TFSI.

19. The battery according to claim 17, wherein:
its cathode current collector is made from a material selected from the group including: Mo, Ti, W, Ta, Cr, Al, alloys based on the aforementioned elements, stainless steel;
its cathode is made of NMC and preferably NMC433, and it has a porous volume of between 30 and 40%, with a conductive layer of carbon deposited in the pores;
its separator is a mesoporous layer of Li₃PO₄, preferably having a thickness of between 6 μm and 8 μm;
its anode is a layer of TiNb₂O_{7-δ}, with 0≤δ≤0.3, preferably doped with a halide and/or germanium, said layer being impregnated by a liquid electrolyte containing lithium salts;
its anode current collector is selected from the group formed by: Mo, Cu, Ni, alloys based on the aforementioned elements, stainless steel.

20. The battery according to claim 17, wherein it has electrodes with a thickness greater than 10 μm.

21. The battery according to claim 17, wherein said anode has a mass capacity greater than 200 mAh/g.

22. The battery according to claim 17, wherein the battery is configured for use at a temperature below −10° C. and/or a temperature higher than 50° C.

23. The method according to claim 2, wherein the electronically conductive oxide material is selected from:
tin oxide (SnO₂), zinc oxide (ZnO), indium oxide (In₂O₃), gallium oxide (Ga₂O₃), a mixture of two of these oxides such as indium-tin oxide corresponding to a mixture of indium oxide (In₂O₃) and tin oxide (SnO₂), a mixture of three of these oxides or a mixture of four of these oxides,
doped oxides based on zinc oxide, the doping being preferably with gallium (Ga) and/or aluminium (Al) and/or boron (B) and/or beryllium (Be), and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped oxides based on indium oxide, the doping being preferably with tin (Sn) and/or gallium (Ga) and/or chromium (Cr) and/or cerium (Ce) and/or titanium (Ti) and/or indium (In) and/or cobalt (Co) and/or nickel (Ni) and/or copper (Cu) and/or manganese (Mn) and/or germanium (Ge),
doped tin oxides, the doping being preferably with arsenic (As) and/or fluorine (F) and/or nitrogen (N) and/or niobium (Nb) and/or phosphorus (P) and/or antimony (Sb) and/or aluminium (AI) and/or titanium (Ti), and/or gallium (Ga) and/or chromium (Cr) and/or cerium (Ce) and/or indium (In) and/or cobalt (Co) and/or nickel (Ni) and/or copper (Cu) and/or manganese (Mn) and/or germanium (Ge).

24. The method according to claim 3, wherein said precursor is selected from organic salts containing one or more metal elements capable, after heat treatment such as calcination, of forming an electronically conductive oxide, and wherein said transformation into electronically conductive material is done by heat treatment such as calcination, preferably performed in air or in an oxidising atmosphere.

25. The anode according to claim 10, wherein material A is selected from the group formed by:
Nb₂O_{5-δ}, Nb₁₈W₁₆O_{93-δ}, Nb₁₆W₅O_{55-δ} with 0≤x<1 and 0≤δ≤2;
TiNb₂O_{7-δ}, Ti₁₋ₓM¹ₓNb_{2-y}M²_{y}O_{7-δ}, Li_{w}Ti₁₋ₓMeₓNb_{2-y}M²_{y}O_{7-δ} wherein M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn, M¹ and M² which can be identical or different from one another, and wherein 0≤w≤5 and 0≤x≤1 and 0≤y≤2 and 0≤δ≤0.3;
Ti₁₋ₓM¹ₓNb_{2-y} M²_{y}O_{7-z}M³_{z}, Li_{w}Ti₁₋ₓM¹ₓNb_{2-y}M²_{y}O_{7-z}M³_{z} wherein
M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn,
M¹ and M² can be identical or different from one another,
M³ is at least one halogen,
and wherein 0≤w≤5 and 0≤x≤1 and 0≤y≤2 and z≤0.3;
TiNb₂O_{7-z}M³_{z}, Li_{w}TiNb₂O_{7-z}M³_{z} wherein M³ is at least one halogen, preferably selected from F, Cl, Br, I or a mixture thereof, and 0<z≤0.3,
Ti₁₋ₓGeₓNb_{2-y}M¹_{y}O_{7-z}, Li_{w}Ti₁₋ₓGeₓNb_{2-y}M¹_{y}O_{7-z}, Ti₁₋ₓCeₓNb_{2-y}M¹_{y}O_{7-z}, Li_{w}Ti₁₋ₓCeₓNb_{2-y}M¹_{y}O_{7-z} wherein
M¹ is at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
and wherein 0≤w≤5 and 0≤x≤1 and 0≤y≤2 and z<1, preferably wherein 0≤w≤5 and 0≤x≤1 and 0≤y≤2 and z<0.3;
Ti₁₋ₓGeₓNb_{2-y}M¹_{y}O_{7-z}M²_{z}, Li_{w}Ti₁₋ₓGeₓNb_{2-y}M¹_{y}O_{7-z}M²_{z}, Ti₁₋ₓLaₓNb_{2-y}M¹_{y}O_{7-z}M²_{z}, Li_{w}Ti₁₋ₓLaₓNb_{2-y}M¹O_{7-z}M²_{z}, Ti₁₋ₓCuₓNb_{2-y}M¹_{y}O_{7-z}M²_{z}, Li_{w}Ti₁₋ₓCuₓNb_{2-y}M¹_{y}O_{7-z}M²_{z}, Ti₁₋ₓCeₓNb_{2-y}M¹O_{7-z}M²z, Li_{w}Ti₁₋ₓCeₓNb_{2-y}M¹_{y}O_{7-z}M²_{z} wherein
M¹ and M² are at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn;
0≤w≤5 and 0≤x≤1 and 0≤y≤2 and z≤0.3;

26. The method according to claim 13, wherein material A is selected from the group formed by:
Nb₂O_{5-δ}, Nb₁₈W₁₆O_{93-δ}, Nb₁₆W₅O_{55-δ} with 0≤x<1 and 0≤δ≤2;
TiNb₂O_{7-δ}, Ti₁₋ₓM¹ₓNb_{2-y}M²_{y}O_{7-δ}, Li_{w}Ti₁₋ₓM¹ₓNb_{2-y}M²_{y}O_{7-δ} wherein M¹ and M² are each at least one element selected from the group consisting of: Nb, V, Ta, Fe, Co, Ti, Bi, Sb, As, P, Cr, Mo, W, B, Na, Mg, Ca, Ba, Pb, Al, Zr, Si, Sr, K, Cs and Sn, wherein M¹ and M² can be identical or different from one another, and wherein 0≤w≤5 and 0≤x≤1 and 0≤y≤2 and 0≤δ≤0.3;
Ti₁₋ₓM¹ₓNb_{2-y}M²_{y}O_{7-z}M³_{z}, Li_{w}Ti₁₋ₓM¹ₓNb_{2-y}M²_{y}O_{7-z}M³_{z} wherein:
M¹ and M² are each at least one element selected from the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn,
M¹ and M² can be identical or different from one another,
M³ is at least one halogen,
and wherein 0≤w≤5 and 0≤x≤1 and 0≤y≤2 and z≤0.3;
TiNb₂O_{7-z}M³_{z}, Li_{w}TiNb₂O_{7-z}M³_{z} wherein M³ is at least one halogen, preferably selected from: F, Cl, Br, I or a mixture thereof, and 0≤w≤5 and 0<z≤0.3;
Ti₁₋ₓGeₓNb_{2-y}M¹_{y}O_{7-z} M²_{z}, Li_{w}Ti₁₋ₓGeₓNb_{2-y}M¹_{y}O_{7-z}M²_{z}, Ti₁₋ₓLaₓNb_{2-y}M¹_{y}O_{7-z}M²_{z}, Li_{w}Ti₁₋ₓLaₓNb_{2-y}M¹O_{7-z}M²_{z}, Ti₁₋ₓCuₓNb_{2-y}M¹_{y}O_{7-z}M²_{z}, Li_{w}Ti₁₋ₓCuₓNb_{2-y}M¹_{y}O_{7-z}M²_{z}, Ti₁₋ₓCeₓNb_{2-y}M¹_{y}O_{7-z} M²_{z}, Li_{w}Ti₁₋ₓCeₓNb_{2-y}M¹_{y}O_{7-z}M²_{z} wherein:
M¹ and M² are at least one element selected from the group consisting of: Nb, V, Ta, Fe, Co, Ti, Bi, Sb, As, P, Cr, Mo, W, B, Na, Mg, Ca, Ba, Pb, Al, Zr, Si, Sr, K, Cs and Sn;
0≤w≤5 and 0≤x≤1 and 0≤y≤2 and z≤0.3;
Ti₁₋ₓGeₓNb_{2-y}M¹_{y}O_{7-z}, Li_{w}Ti₁₋ₓGeₓNb_{2-y}M¹_{y}O_{7-z}, Ti₁₋ₓCeₓNb_{2-y}M¹_{y}O_{7-z}, Li_{w}Ti₁₋ₓCeₓNb_{2-y}M¹_{y}O_{7-z} wherein
M¹ is at least one element selected from the group consisting of: Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
and wherein 0≤w≤5 and 0≤x≤1 and 0≤y≤2 and z<1, preferably wherein 0≤w≤5 and 0≤x≤1 and 0≤y≤2 and z<0.3

27. The method according to claim 13, wherein the deposit is performed by a method selected from the group including:
electrophoresis;
extrusion;
a printing method, selected preferably from: inkjet printing and flexographic printing;
and a coating method, preferably selected from: roll coating, curtain coating, doctor blade coating, coating by extrusion through a slot die, dip coating.
